(19) United States
(12) Patent Application Publication
(10) Pub. No.: US 2026/0002373 A1
(43) Pub. Date: Jan. 1, 2026

(54) SYSTEM AND METHOD FOR RAPID DEPLOYMENT ROBOTIC SELF-INSTALLING & SELF-LEVELING OF PAYLOAD STRUCTURES

(71) Applicant: SITU-Places, Inc., Santa Cruz, CA (US)

(72) Inventors: Stephen W. Jaycox, Natick, MA (US); Quentin Topping, Santa Cruz, CA (US)

(73) Assignee: SITU-Places, Inc., Santa Cruz, CA (US)

(21) Appl. No.: 18/831,642

(22) Filed: Jun. 23, 2025

Related U.S. Application Data
(63) Continuation-in-part of application No. 18/646,615, filed on Apr. 25, 2024.
(60) Provisional application No. 63/498,244, filed on Apr. 25, 2023.
(60) Provisional application No. 63/662,612, filed on Jun. 21, 2024.

(51) Int. Cl. E04H 1/12; E02D 5/56; E02D 7/22; E02D 13/04; E02D 27/14; E02D 35/00; G05B 6/02

(52) U.S. Cl. CPC E04H 1/1205; E02D 5/56; E02D 7/22; E02D 13/04; E02D 27/14; E02D 35/00; G05B 6/02; E02D 2600/10; E04H 2001/1283

(57) ABSTRACT

Methods and Systems provide for a Rapid Deployment Robotic Self-Installing and Self-Leveling Payload Structure (hereinafter, “RDR-PC”) anchors a payload structure to site with no prior site preparation. The RDR-PC is ideal for remote, and/or difficult installations-whether on/off world-where deployment/development speed is critical and prior access to site is impractical, limited, or impossible. Leave-no-trace removal of the same system is achieved by reverse process.

### CROSS-REFERENCE TO RELATED CASES

This application is a continuation-in-part of U.S. patent application Ser. No. 18/646,615, entitled “Integrated Foundation Leveling System,” filed Apr. 25, 2024, which claims priority to U.S. Provisional Patent Application No. 63/498,244 entitled “Integrated Foundation Leveling System,” filed Apr. 25, 2023; and this application claims priority to U.S. Provisional Patent Application No. 63/662,612, entitled “System And Method For Rapid Deployment Robotic Self-Installing [And] Self-Leveling Of Payload Structures,” filed on Jun. 21, 2024, each of which is hereby incorporated by reference. This application is related to: U.S. patent application Ser. No. 18/306,953, entitled “System And Method For Robotics-Assisted Foundation Installation, filed on Apr. 25, 2023, now U.S. Pat. No. 11,946,218, issued Apr. 2, 2024; U.S. patent application Ser. No. 18/049,964, entitled “System And Method For Robotics-Assisted Foundation Installation, filed on Oct. 26, 2022, now U.S. Pat. No. 11,859,363, issued Jan. 2, 2024; and U.S. Provisional Patent Application No. 63/272,055, entitled “System And Method For Robotics-Assisted Foundation Installation, filed on Oct. 26, 2021, each of which is hereby incorporated by reference.

### TECHNICAL FIELD

The claimed subject matter relates generally to the field of construction and more specifically to the installation of the structure-supporting foundations and columns the mission leveling of modular infrastructure deployed to site in Payload Containers. The claimed subject matter is pertinent to both civilian and governmental infrastructure development/operations and also relates to off-world exploration, development and colonization.

### BACKGROUND

There is an increasing need to be able to deploy ground-anchored modular infrastructure for data center, communication, energy, mining and/or refinement, scientific research and/or exploration, disaster response, security, and/or defense operations in a readymade and shippable form factor (hereinafter referred to as “Payload Containers”) to remote and/or difficult sites where site preparation such as site clearance, grading and/or soils compaction in advance of deployment is impractical, costly, and/or impossible with conventional construction systems and methods. Such sites may be characterized as (but not limited to) mountainous, desert, coastal, underwater, and/or severe weather impacted environmental topographies (flooding, soils erosion and/or permafrost thaw) having soil/substrate conditions which vary from sand/coral, soil/rock, permafrost or ice conditions. Such sites may be either on-or off-world. Need may also exist on brownfield sites, or the various types of conditions in which site soil/substrates may be contaminated and/hazardous to the extent that regulation and/or safety concerns recommend or require that soils/substrate disturbance be minimized to the greatest extent possible.

In addition to the above, there is a need for such Payload Containers to be anchored to site deployment with a ground-anchored foundation that delivers both sink, rotational, and uplift resistance respective to the Payload Container's load with minimal to no workforce present. Similarly, there is a need to be able to initially set, monitor and maintain the level-state (herein after referred to as the “mission level”) of the Payload Container to the operational specification of a Payload Container's contents (systems, equipment, machinery) with minimal to no workforce present.

### SUMMARY

Embodiments for an autonomous or, semi-autonomous and remote-controlled system that allows the types of Payload Containers described above to be self-installing, meaning that equipment either added to, or integrated into a Payload Container's structure would fulfill the function of achieving foundation anchorage by autonomous means or that could either entirely, or in a gate-checked fashion, be controlled by a remote operator. Embodiments provide a system that may reverse its installation in a manner that allows the Payload Container to be subsequently removed from site to leave no substantial material or chemical trace of its prior installation or removal.

Understanding that foundation anchorage alone may not be sufficient for a wide variety of Payload Container operations that additionally require axial orientation in three-dimensional space to be set to a specified mission level, in embodiments the autonomous or semi-autonomous or remotely controlled system may level the payload structure once foundation anchorage has been achieved. In embodiments, the system may then monitor the level condition of the payload structure and make any needed adjustments over time to correct for differential settlement trends.

Thus, embodiments include Methods and Systems that realize a Rapid Deployment Robotic Self-Installing and Self-Leveling of Payload Container (hereinafter, an “RDR-PC”), that can be deployed to any site, but is especially useful in its activation of deployment sites where no site visit, or preparation, is possible prior to installation. An RDR-PC is well-suited for remote, and/or difficult deployments-whether on/off world-wherever deployment speed is critical, access is limited, and installation by conventional construction means would be too difficult or too costly to realize. An RDR-PC is created when a Payload Container (which may be either a readymade or a custom-built structure) is equipped with an RDR-SISL Kit. Use of an RDR-SISL Kit provides maximum flexibility allowing Payload Containers to arrive at site by any means: whether truck, crane, helicopter or VTOL aircraft, dirigible airship, spacecraft, or parachute. An RDR-SISL-Kit may be attached to any existing Payload Container (occupied or unoccupied), whether a conventional 6-sided (such as, but not limited to, intermodal shipping containers), cylindrical, or poly-sided form (the latter two, if within a structural frame) that is dimensionally stable relative to intrinsic live and dead loads. An RDR-SISL Kit can also be design and engineering integrated with a purpose-built Payload Container package. The composite outcome of either the adaptation of an existing Payload Container or integration within a purpose-built Payload Container results in an RDR-PC. An RDR-PC may be installed on any site, including ones that are not considered level for construction purposes. An RDR-PC may tolerate installation on sites with a maximum slope of 45 degrees and a maximum cross-slope of 45 degrees. Present day use cases include (but are not limited to): military, mining, energy, data/communications, A.I.-supporting infrastructure, scientific research/monitoring, government-organized disaster response and climate-change response. Future contemplated uses: government or private entity off-world deployments for any of the above (or other) use cases.

### BRIEF DESCRIPTION OF THE DRAWINGS

The embodiments are illustrated by way of example and not limitation in the figures of the accompanying drawings, in which like references indicate similar elements, and in which:

FIG. 1 is a diagram illustrating several common form-factors of a Payload Container for reference. To reduce iterative figures, the 6-sided rectangular (CONEX/shipping container) box will be the Payload Container included in subsequent illustrations for brevity. The simplified diagrams below illustrate some other common Payload Container form-factors;

FIG. 2 is a diagram illustrating a typical Payload Container with an RDR-SISL Kit installed external to the Payload Container to comprise a variation of an embodiment of an RDR-PC in its “shipping” state. The simplified diagrams below illustrate how such an RDR-SISL Kit may be installed to some other Payload Container form-factors;

FIG. 3A and FIG. 3B are diagrams of an RDR-PC embodiment with is functional components in an “installed” state viewed along short and long axes, respectively;

FIG. 4A and FIG. 4B are diagrams illustrating short-axis and long-axis elevational views, respectively, of aspects of an embodiment of an RDR-PC at arrival to site environs by one of a variety of means;

FIG. 5A and FIG. 5B are diagrams illustrating short-axis and long-axis elevational views, respectively, of aspects of an embodiment of an RDR-PC as it touches down to soil/substrate into which it will be installed;

FIG. 6A and FIG. 6B are diagrams illustrating short-axis and long-axis elevational views, respectively, of aspects of an embodiment of an RDR-PC at the start-up of autonomous, semi-autonomous and/or remotely operated process in which components are unlocked and made free to align with the vector of gravity;

FIG. 7A and FIG. 7B are diagrams illustrating short-axis and long-axis elevational views, respectively, of aspects of an embodiment of an RDR-PC in a state of a subsequent operation of the autonomous, semi-autonomous and/or remotely operated process in which components adjust so that the RDR-PC is itself not an obstacle to gravity alignment of components;

FIG. 8A and FIG. 8B are diagrams illustrating short-axis and long-axis elevational views, respectively, of aspects of an embodiment of an RDR-PC in a state of a subsequent operation of the autonomous, semi-autonomous and/or remotely operated process in which foundation supports are drilled into deployment site soil/substrate;

FIG. 9 is a diagram illustrating an embodiment of RDR-SISL Kit components;

FIG. 10 is an Apparatus diagram illustrating an attachment embodiment of an RDR-PC 501;

FIG. 11 is an exploded-view diagram illustrating an embodiment of RDR-SISL Kit components relative to an embodiment of Payload Container;

FIG. 12 is an Apparatus diagram illustrating representative parts of an attachment embodiment of a RDR-SISL Kit in greater detail;

FIGS. 13A and 13B are diagrams showing two possible states of an RDR-SISL Kit Telescoping Drilling/Leveling Actuator that performs foundation drilling, foundation support and level adjustment functions of the RDR-SISL Kit. FIG. 13A illustrates the “shipping” state in which the Telescoping Drilling/Leveling Actuator is at its shortest length (dashed outline illustrates its interior position), while FIG. 13B illustrates a sectional view of one possible length of the Telescoping Drilling/Leveling Actuator in an installed state”;

FIGS. 14A, 14B, 14C, and 14D are diagrams illustrating an embodiment of the incorporation of helical bearing blades in an RDR-SISL Kit's Telescoping Drilling/Leveling Actuator. FIGS. 14C, 14D, and 14E illustrate an embodiment of a helical pier segment commonly available in the marketplace. FIG. 14B illustrates an embodiment of incorporation.

FIGS. 15A, 15B, and 15C are diagrams illustrating an embodiment of the incorporation of a microjet grouting system in an RDR-PC (FIG. 15C), and an embodiment of microjet grout jet ports integrated into an RDR-SISL Kit's Telescoping Drilling/Leveling Actuator (FIG. 15B);

FIGS. 16A and 16B are diagrams illustrating sectional views of an embodiment of an RDR-SISL Kit's range-limited ball joint that allows an RDR-SISL Kit's Telescoping Drilling/Leveling Actuator to freely align to the vector of gravity without active actuation; andillustrating an embodiment of an RDR-SISL Kit's sensor locations;

FIG. 17A is an Apparatus diagram illustrating an attachment embodiment of an RDR-PC 501 with a retracted Lower Stabilization Arm with disengaged Lower Stabilization Arm Mechanical Attachment Clamp;

FIG. 17B is an Apparatus diagram illustrating an attachment embodiment of an RDR-PC 501 with an attached Lower Stabilization Arm with Lower Stabilization Arm Mechanical Attachment Clamp engaged to its counterpart Attachment Tab;

FIG. 18 is an Apparatus diagram illustrating an attachment embodiment distribution of Sensor Stacks which report data to the DAPU;

FIG. 19 is an exemplary block diagram depicting and embodiment of a system for implementing embodiments of methods in the disclosure; and

FIG. 20 is an exemplary block diagram depicting a computing device.

### DETAILED DESCRIPTION

Embodiments describe a System and Method for a Rapid Deployment Robotic Self-Installing and Self-Leveling Payload Container (hereinafter, “RDR-PC”) that contemplate the installation of modular, off-site produced, Payload Container(s) on deployment sites with no requirements for prior site visitation or preparation.

A target for embodiments of an RDR-PC solution is the installation of Payload Container(s) at remote, and/or difficult deployment sites-whether on/off world-where deployment/development speed is critical and prior site access is impractical, limited, or impossible in advance.
Embodiments of an RDR-PC provide maximum flexibility allowing Payload Containers to arrive at site by any means: whether truck, crane, helicopter or other VTOL aircraft, dirigible airship, spacecraft, or parachute.
Embodiments of an RDR-SISL Kit can be attached to any existing Payload Container (occupiable or non-occupiable) whether a conventional 6-sided CONEX box/intermodal shipping container, or other form-factors such as (but not limited to): spherical, cylindrical, or regular/irregular poly-sided Payload Containers to realize a composite RDR-PC.
Embodiments of an RDR-SISL-Kit can also be integrated through design and engineering into a purpose-built Payload Container to realize a composite RDR-PC.
Embodiments of a System and Method for a Rapid Deployment Robotic Self-Installing and Self-Leveling Payload Container may be installed on any site, including ones that are not considered level for construction purposes. An RDR-PC may tolerate installation on sites with a maximum slope of 45 degrees and a maximum cross-slope of 45 degrees.

However, the center of gravity of an RDR-PC may further limit the maximum slope a RDR-PC can be installed upon without risk of overturning.

Soils conditions where RDR-PC's may be installed must be appropriate for helical pier/screw pile structural attachment to site.

To the extent that the Payload Container portion of a composite RDR-PC qualifies for either partial or complete immersion in water, the embodiments of an RDR-SISL Kit may be adapted use in water to facilitate anchorage to soil/sand/coral substrates deemed adequate to support total RDR-PC weight and the lateral forces it will be exposed to.
Embodiments of the RDR-SISL Kit involves movable parts, motion guided by actuation systems and/or gravitational force (where applicable) and/or other surveying/locational means involving target acquisition technology for the accurate guidance of linear, rotational, and planetary actuators, dual direction telescoping hardware, and on/off position mechanical fasteners for both “shipping” and “installing” states of components of an RDR-SISL Kit.

Present day use cases include (but are not limited to): military, mining, energy, data/communications, A.I.-supporting infrastructure, scientific research/monitoring, government-organized disaster response and climate-change response.

Future contemplated uses: government or private entity off-world deployments for any of the above (or other) use cases.

### Apparatus Description

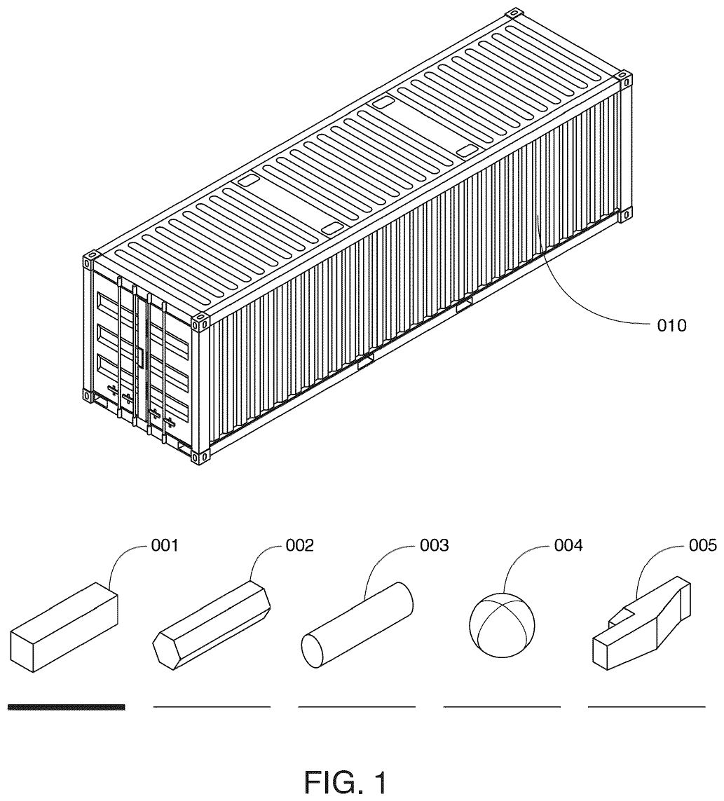

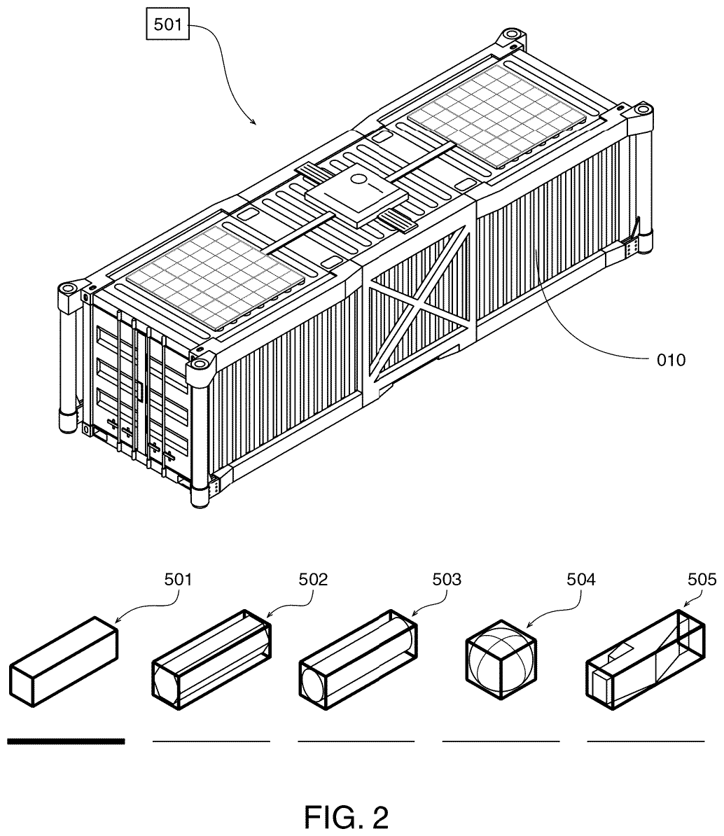

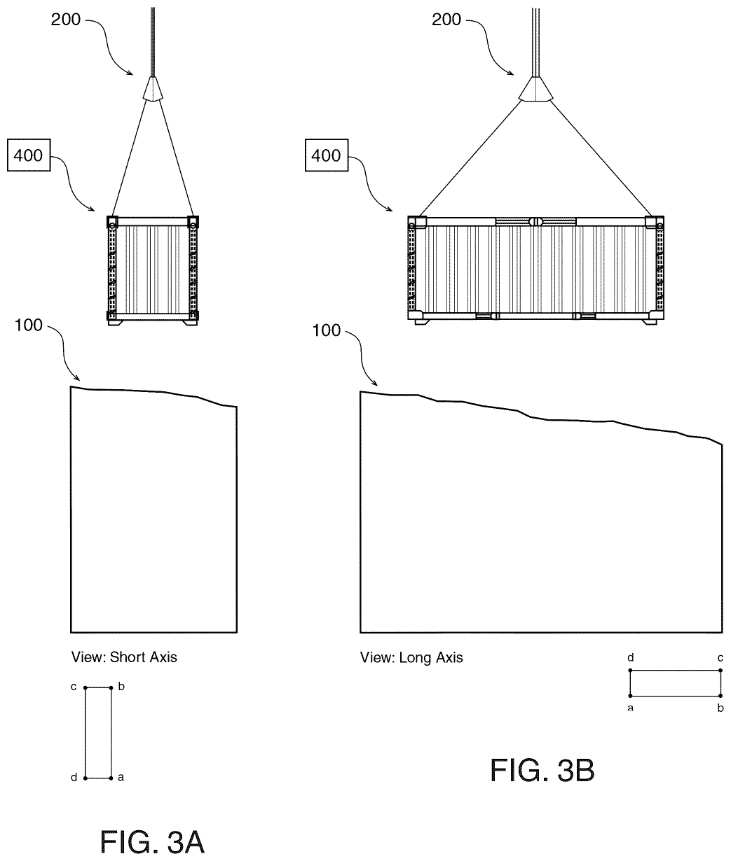

FIG. 1 is a Reference diagram illustrating a Payload Container in its most recognizable form: a CONEX box (commonly known as an intermodal shipping container) 010. A CONEX box is generally produced by others, is commonplace in the market, and is available in a range of common sizes. This disclosure makes no claim relative to intrinsic qualities of a readymade Payload Container, but rather, the Claims of this disclosure focus on the improvement of a Payload Container with a Method and System of functional intentions achieved by method processes and component parts (referred to as an RDR-SISL Kit) that may be incorporated either by attachment, or by integration, to a Payload Container to realize an RDR-PC. The figures that follow contemplate at least two general types of RDR-PC embodiment:
(a) one that is realized through attachment of an RDR-SISL Kit to a Payload Container such as is shown in the embodiment illustrated in FIG. 2, labeled 501, and;
(b) one that is realized though integration of RDR-SISL Kit functionality into a reconciled design of a Payload Container thus creating a new hybrid embodiment in which the RDR-SISL-Kit can be neither attached, nor separated, from its payload volume enclosure such as is shown in the embodiment illustrated in FIG. 3, labeled 400. The additional shapes illustrated in FIG. 1 elaborate on a range of other possible Payload Container form factors that an embodiment of an RDR-SISL Kit may be attached to. These include 6-sided quadrilateral CONEX box volumetric forms in a variety of standard and non-standard proportions 001, poly-sided volumetric forms of regular geometry 002, cylindrical volumetric forms 003, spherical volumetric forms 004, and any possible irregular poly-sided volumetric forms 005. These are provided to illustrate the term Payload Container, as used in this document, but do not intend to limit the range of Payload Container form factors that an embodiment of an RDR-SISL Kit may be attached to.

Element 010: is a generalized embodiment of a CONEX box commonly known as a shipping container, or an intermodal shipping container.

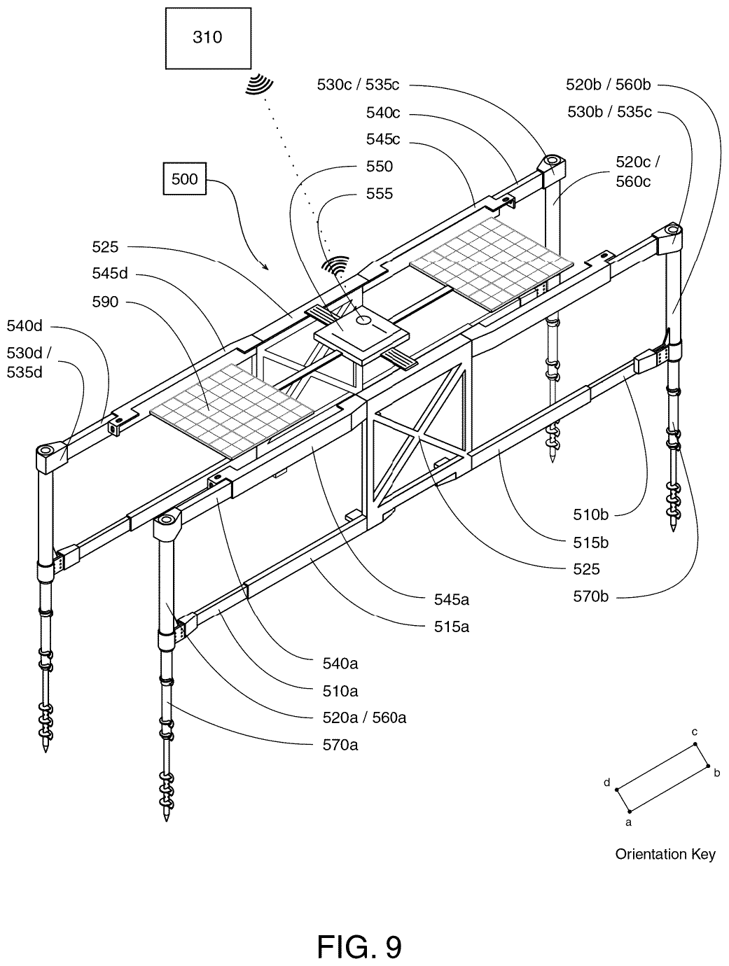

FIG. 2 is an Apparatus diagram illustrating an attachment embodiment of RDR-PC 501 as realized through the mounting of an RDR-SISL Kit (500, as elaborated upon in subsequent FIG. 9) to a CONEX box (010, as shown in FIG. 1) Payload Container. The additional shapes illustrated in FIG. 2 elaborate on a range of other possible embodiments of an RDR-PC that result when an RDR-SISL Kit is attached to Payload Containers of various form factors. These include 6-sided quadrilateral CONEX box volumetric forms in a variety of standard and non-standard proportions 501, poly-sided volumetric forms of regular geometry 502, cylindrical volumetric forms 503, spherical volumetric forms 504, and any possible irregular poly-sided volumetric forms 505. These examples do not intend to limit the range of possible RDR-PC form factors that may be achieved through embodiments of an RDR-PC Kit attached to a Payload Container, but rather, illustrate the versatility of the Methods and Systems represented in this disclosure.

Element 501: is an attachment type of embodiment of an RDR-PC that is an assembled composite of an embodiment of an RDR-SISL Kit and an embodiment of a CONEX box 010.

FIG. 3A and FIG. 3B are step 1 Method and Apparatus diagrams illustrating short-axis and long-axis elevational views of aspects of an integrated type of embodiment of an RDR-PC 400 (a designed and engineered composite of a type of Payload Container and an RDR-SISL Kit) as it arrives to the installation Site 100 by one of a variety of means. For illustration purposes, crane conveyance means 200 is shown. Note that both the short and long axial views are illustrated only to describe the ability of the system to operate on sites with both slopes and cross-slopes relative to the placement geometry of the RDR-PC integrated embodiment 400 on Site 100.

Element 400: is an integrated type of embodiment of an RDR-PC that is a designed and constructed iteration incorporating all functions and systems of an RDR-SISL Kit into a novel RDR-PC embodiment.

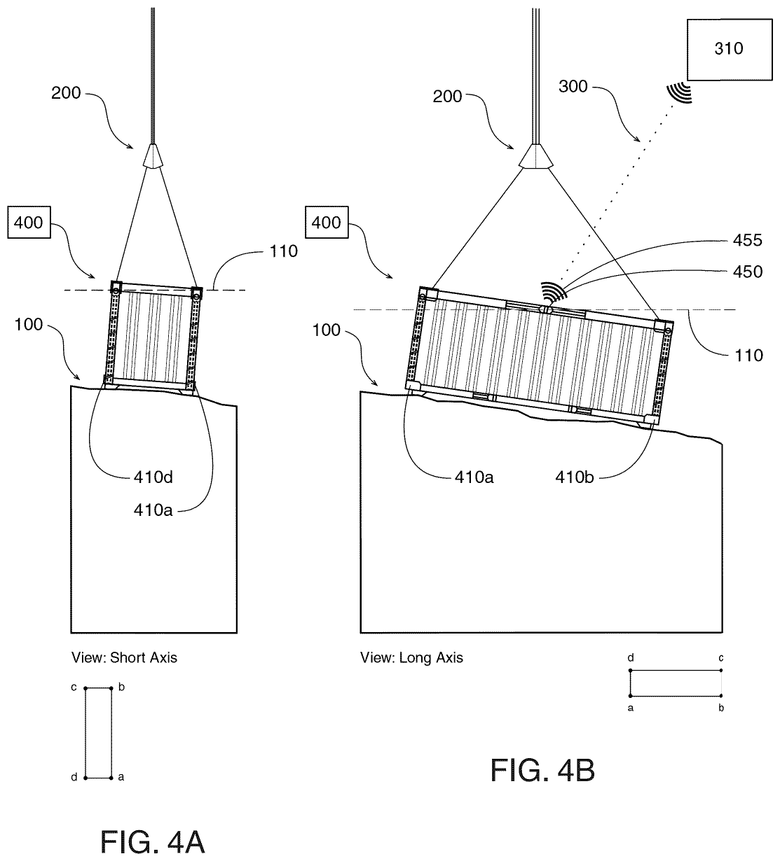

FIG. 4A and FIG. 4B are step 2 Method and Apparatus diagrams illustrating short-axis and long-axis elevational views of aspects of an integrated type of embodiment of an RDR-PC 400 as touchdown contact is made with installation Site 100 just prior to the removal of the Conveyance Means 200. Once the RDR-PC 400 landed on installation Site 100, the computation, communications, and technology systems on-board the RDR-PC 400 are activated and Sensor Stacks report on their acquired three-dimensional positions so that the Data Acquisition and Processing Unit (DAPU) 450 may computationally determine the unit's position relative to Site Level Plane 110 (perpendicular to the gravity vector) from reconciled data. Following the processing of this data, the RDR-PC 400 wirelessly communicates 300 from an On-board Communications Systems 455 to a communications-enabled Remote Computing System 310, the RDR-PC 400's installation status and/or to request an authorization to proceed, unless the system is set to proceed automatically. Thereafter, the initiation of autonomous, semi-autonomous and/or remotely operated processes is either automatically, or remotely initiated to commence the process of RDR-PC 400 installation and mission leveling. Proceeding to the next step of installation is either automatic or via communication with a communications-enabled Remote Computing System 310 to which present status is reported and an authorization to proceed requested, and either approved or denied, unless the system is set to proceed automatically.

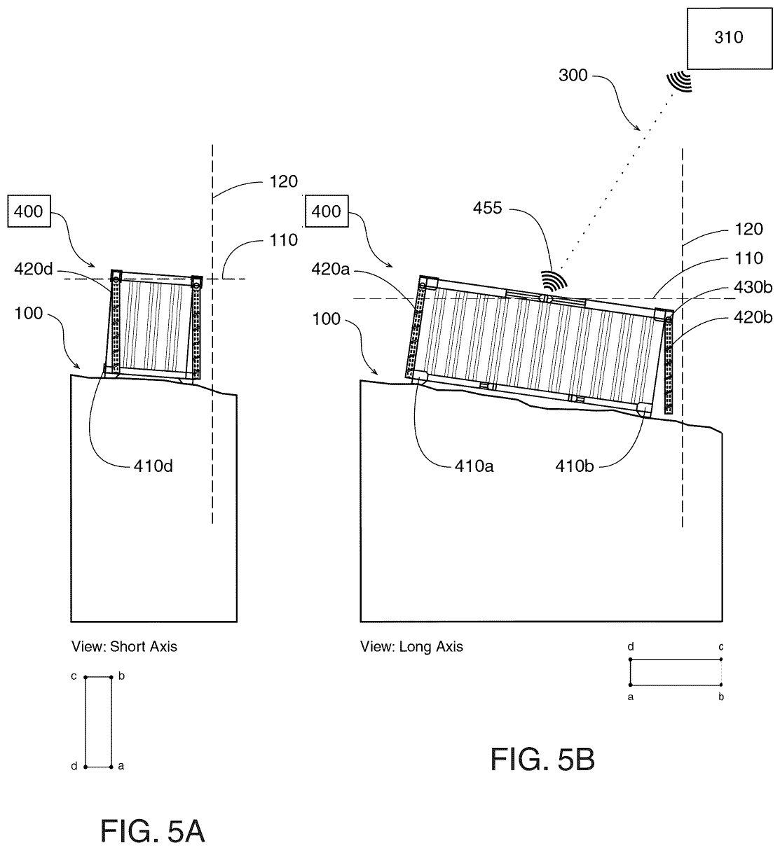

FIG. 5A and FIG. 5B are step 3 Method and Apparatus diagrams illustrating short-axis and long-axis elevational views of aspects of an integrated type of embodiment of an RDR-PC 400 in its first process step once conveyance means 200 (shown on FIGS. 3 and 4) have been removed and the autonomous, semi-autonomous and/or remotely controlled process has been initiated. In this step, a plurality of Lower Stabilization Arms 410x release a plurality of Telescoping Drilling/Leveling Actuators 420x from their “shipping” positions by mechanical release. The Telescoping Drilling/Leveling Actuators 420x then align to the site gravity vector 120 by either by exploiting the force of gravity or by calculated and driven means by a plurality of Range-limited Ball Joints 430x if unimpeded by Payload Container obstacles. Proceeding to the next step of installation is either automatic or via communication 300 from an On-board Communications System 455 with a communications-enabled Remote Computing System 310 to which present status is reported and authorization to proceed is requested, and thereafter, either approved or denied, unless the system is set to proceed automatically.

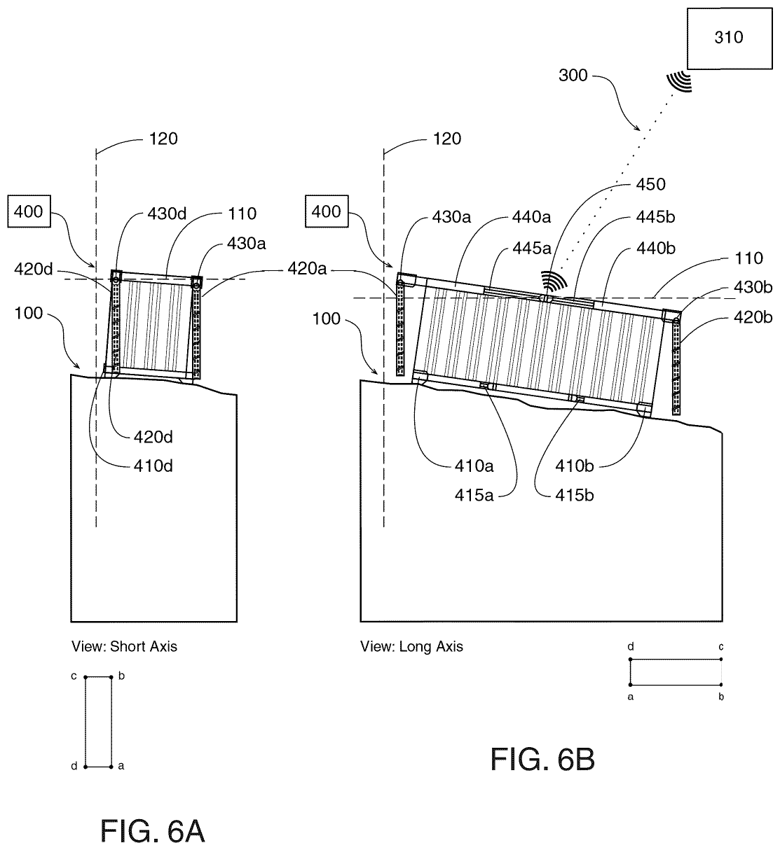

FIG. 6A and FIG. 6B are step 4 Method and Apparatus diagrams illustrating short-axis and long-axis elevational views of aspects of an integrated type of embodiment of an RDR-PC 400 in a subsequent state in which, if an obstacle to the alignment of Telescoping Drilling/Leveling Actuators 420x to the gravity vector 120 has been detected, then Upper Positioning Arms 440x are extended to an outboard position by Upper Actuators and Motors 445x. The on-board DAPU 450 then confirms through sensor query that the plurality of Telescoping Drilling/Leveling Actuators 420x are free to align to the site gravity vector 120 and have achieved the same through the unrestricted passive performance of the Range-Limited Ball Joint 430x. If this has not been achieved, then active mechanical positioning adjustment will follow by actuation at the Range-Limited Ball Joint 430x assembly. Proceeding to the next step of installation is either automatic or via communication 300 with a communications-enabled Remote Computing System 310 to which present status is reported and authorization to proceed is requested, and thereafter, either approved or denied, unless the system is set to proceed automatically.

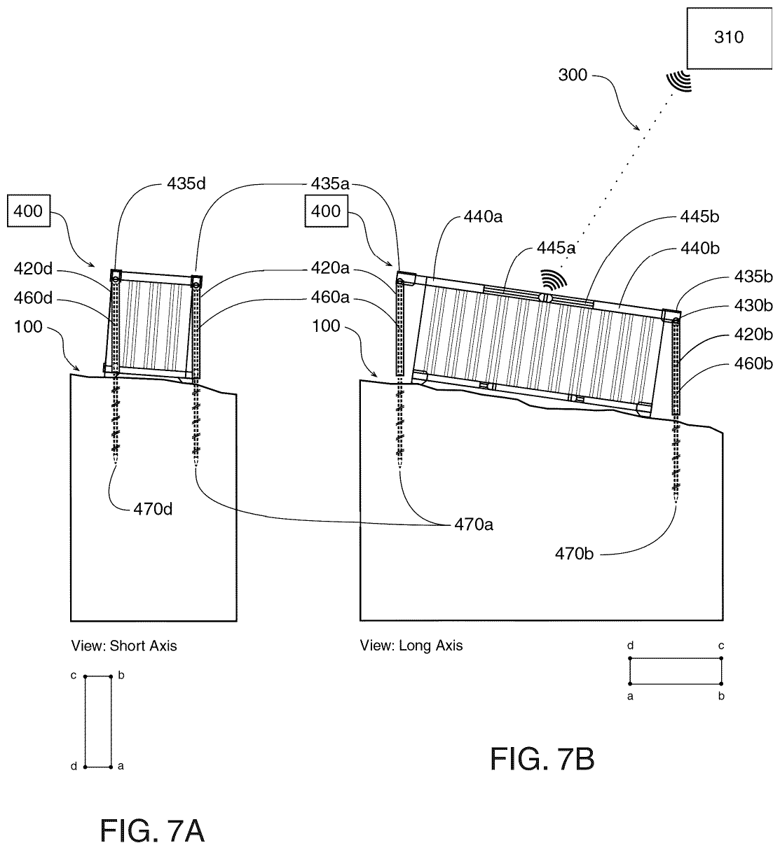

FIG. 7A and FIG. 7B are step 5 Method and Apparatus diagrams illustrating short-axis and long-axis elevational views of aspects of an integrated type of embodiment of an RDR-PC 400 in a subsequent state in which a plurality of Telescoping Drilling/Leveling Actuators 420x activate interior dual-direction telescoping mechanisms 460x that rotationally drill Foundation Piers augmented with Helical Bearing Plates 470x into Site substrate 100 until bearing capacity is detected by Sensor Stack (positioning, accelerometers, inclination, etc. sensors) 435x located proximate to the Range-limited Ball Joints 430x. Proceeding to the next step of installation is either automatic or via communication with a communication-enabled Remote Computing System 310 to which present status is reported and authorization to proceed is requested, and thereafter, either approved or denied, unless the system is set to proceed automatically.

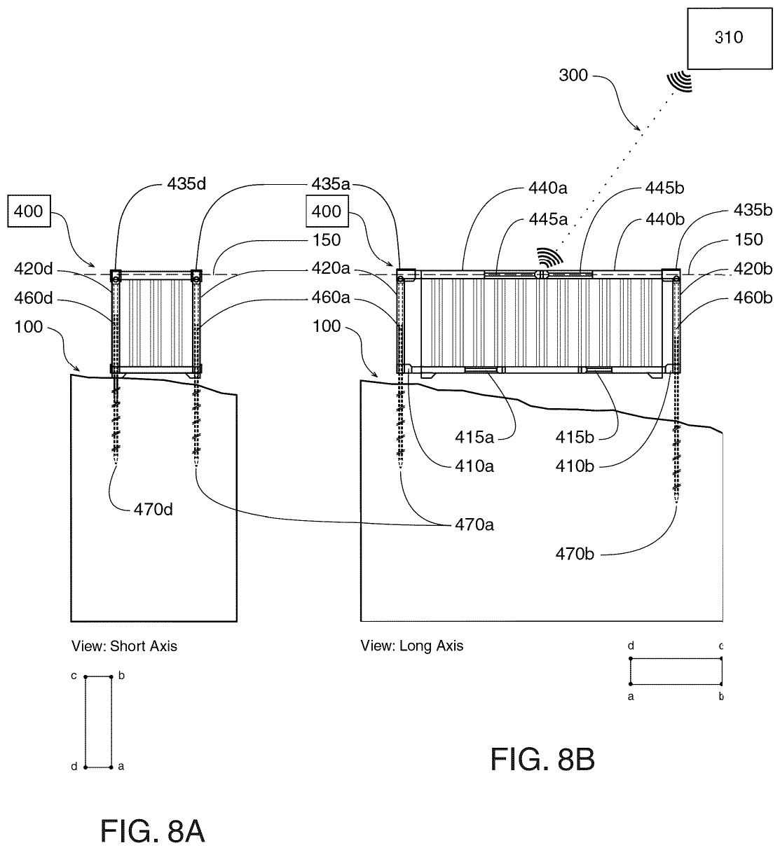

FIG. 8A and FIG. 8B are step 6 Method and Apparatus diagrams illustrating both short-axis and long-axis elevational views of aspects of an integrated type of embodiment of an RDR-PC 400 in a subsequent state in which, once bearing capacity is detected through the DAPU (450, FIG. 6) reconciliation of a data from a plurality of Sensor Stacks 435x associated with a Telescoping Drilling/Leveling Actuators 420x, then the interior dual-direction telescoping mechanisms 460x bring the RDR-PC 400 to a Mission Level position 150 in a coordinated fashion relative to a plurality of Telescoping Drilling/Leveling Actuators 420x in a manner that minimizes eccentric weight loading during the lifting process and optimizes ground clearance in satisfaction of prior defined engineering specification or instruction received via communication with a communications-enabled Remote Computing System 310. Proceeding to the next step of installation is either automatic or via communication 300 with a communications-enabled Remote Computing System 310 to which present status is reported and authorization to proceed is requested, and thereafter, either approved or denied, unless the system is set to proceed automatically. The next step is to instruct a plurality of Lower Stabilization Arms 410x to mechanically re-attach to Telescoping Drilling/Leveling Actuators 420x through re-positioning by a plurality of Lower Actuators and Motors 415x in order to achieve installed system structural dimensional stability and resistant to bending and shear forces. A plurality of Foundational Piers augmented with Helical Bearing Plates 470x remain installed in Site substrate 100 for the duration of the operational deployment of a RDR-PC 400. The system continuously monitors Mission Level position 150 and if/when a differential settlement trend, or loss of bearing capacity is detected by a Sensor Stack 435x, communication with the communications-enabled Remote Computing System 310 is reactivated, present status is reported, and authorization to initiate a correction process is requested, and thereafter, either approved or denied, unless the system is set to proceed automatically. Thereafter, if authorized, the Telescoping Drilling/Leveling Actuators 420x reactivate interior dual-direction telescoping mechanisms 460x to restore an RDR-PC 400 to Mission Level position 150 relative to site 100 to the extent that bearing capacity can be re-established.

FIG. 9 is an Apparatus diagram illustrating an embodiment of key Elements to an RDR-SISL Kit 500 for attachment to a Payload Container (not shown) that, when combined, realize a RDR-PC (not shown). These Elements are also included in an RDR-PC achieved through integration such as the type of RDR-PC 400 shown on FIGS. 3 through 8, however the physical appearance may vary and/or not be visible from an exterior view of the same.

Element 310: A cloud computing system (hardware and software) that can communicate with a site installed system(s), run an analysis program that compares data sets and can publish results back to the site installed system(s) and to an application dashboard and send notifications by email and push notifications (whether in-app or by text messaging services).

Element 510: is an attachment embodiment of a type of Lower Stabilization Arm, that can be repositioned through linear actuation and participate in either releasing a mechanical connection to element 520 to allow freedom of movement of 520 during installation process, and/or make a mechanical connection to element 520 to complete a structural frame when re-attached upon completion of installation and/or for securing element 520 during shipment of composite RDR-PC (501, FIG. 2). The measure of extension among a plurality of Lower Stabilization Arms 510 need not be equal.

Element 515: is an attachment embodiment of a type of Lower Motors and Actuators, which in assembly, power the linear repositioning of the Lower Stabilization Arm 510.

Element 520: is an attachment embodiment of a type of Telescoping Drilling/Leveling Actuator that provides, through telescoping internal components, both the Self-Installation function of the in-ground/substrate foundation element required to anchor the composite RDR-PC (501, FIG. 2), and the Self-Leveling function to achieve a Mission Level state of completed RDR-PC (502, FIG. 2), deployment installation.

Element 525: is an attachment embodiment of a type of Load Transfer Brace with System Power and Communications Routing that both leverages and augments a Payload Container's structural performance to tolerate the additional and eccentric transfer forces such an installation process requires. The same element 525 facilitates the routing of both Power and Communications conduit and cable distribution to reach all assembled elements in a composite embodiment of an RDR-PC (501, FIG. 2).

Element 530: is an attachment embodiment of a type of Range-limited Ball Joint that allows Element 520 freedom to passively align to the vector of gravity and/or to be mechanically manipulated to a target vector (of gravity, or otherwise) to facilitate an installation process. The Range-limited Ball Joint 530 also provides a type of mechanical braking to fix the Ball Joint in a required position once achieved, and released when the position is no longer required.

Element 535: is an attachment embodiment of a type of Sensor Stack that may include one or multiple sensors that can report on one or more of: physical location, acceleration, inclination, deformation, stress, and assigned ID, and include communications and power elements.

Element 540: is an attachment embodiment of a type of Upper Positioning Arm that can be repositioned through linear actuation to allow element 520 an unobstructed range of motion, clear of the limits of a Payload Container, to align to the vector of site gravity (or other specified vector). The measure of extension among a plurality of Upper Positioning Arms 540 need not be equal.

Element 545: is an attachment embodiment of a type of Upper Actuators and Motors, which in assembly, power the linear repositioning of the Upper Positioning Arm 540.

Element 550: is an attachment embodiment of a generalized Data and Power Acquisition Unit (DAPU) that locally controls the installation, leveling, monitoring and correction, and de-installation processes of a Rapid Deployment Robotic Self-Installing and Self-Leveling of Payload Container following either pre-set or received instructions.

Element 555: is an attachment embodiment of a generalized On-board Communications System reconciled to the type and protocols of the cloud computing system 310 to be used over the life cycle of the installation deployment.

Element 560: is an attachment embodiment of a type of Dual-Direction Telescoping Mechanism as either entirely or partially located within the interior of element 520 to leverage 520's structural casing as a component of actuation. Telescoping threaded pipes in an assembly driven by a combination of planetary roller and linear actuation (movement and braking) allow for an extension of telescoping assembly that is greater than the measured length of element 520 by a multiple, or greater. The rotational drive of the telescoping assembly facilitates the drilling function required to install in-ground foundation components characterized as piers (see Element 570). Subsequently, a multi-stage rotational drive allows a process of increasing or diminishing installed height an RDR-PC (501, FIG. 2) once required foundational bearing capacity has been achieved. In this way, a plurality of Dual-Direction Telescoping Mechanisms are able to establish and maintain a target Mission Level for an RDR-PC (501, FIG. 2) through coordination.

Element 570: is an attachment embodiment of type of Foundational Pier Augmented with Helical Bearing Plates that is adapted to the material, design and component operation of element 560 as housed within element 520 in performance criteria-specific configuration and form.

Element 590: is an attachment embodiment of a generalized On-board Photovoltaic System that converts solar-acquired energy into battery storable energy to be used to power the installation and maintenance of an RDR-PC (501, FIG. 2) through deployment lifecycle.

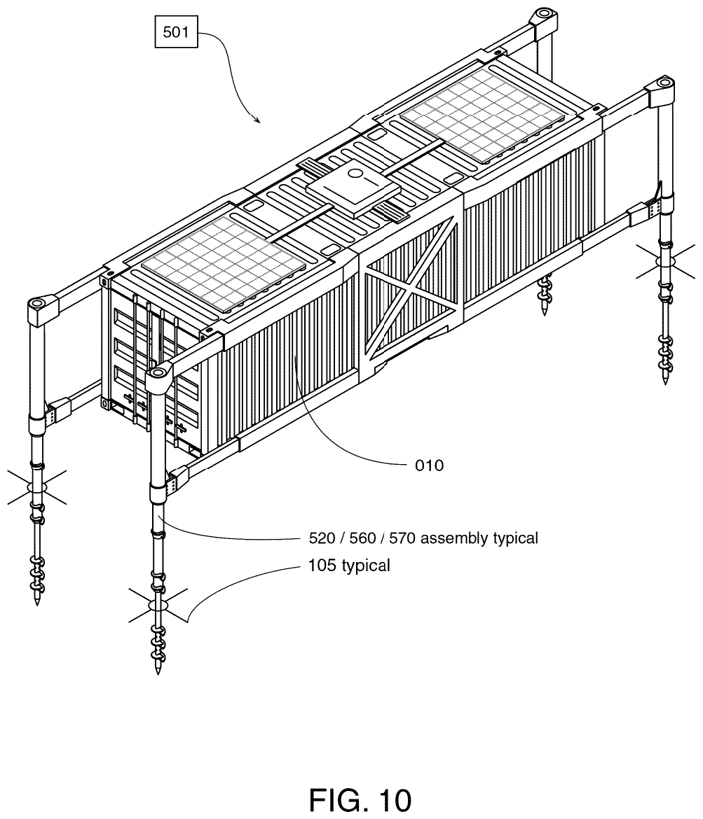

FIG. 10 is an Apparatus diagram illustrating an attachment embodiment of an RDR-PC 501. This illustration elaborates on element 501 as shown in FIG. 2 by illustrating the installed state of a plurality of Telescoping Drilling/Leveling Actuator 520 assemblies (and related sub-elements comprised of elements 560 and 570) relative to a plurality of hypothetical grade penetrations 105. Whereas, FIG. 9 intentionally omitted illustration of a Payload Container 010 to most clearly illustrate key elements to an RDR-SISL Kit, this figure includes representation of a Payload Container 010 to illustrate an attachment type embodiment of an RDR-PC 501.

Element 105: is a symbol representing a hypothetical grade penetration located along the axis of a plurality of Foundational Pier Augmented with Helical Bearing Plates elements (570, FIG. 9) to illustrate the relationship between the installed RDR-PC deployment and the finished grade (whether prepared, or unprepared) of the site.

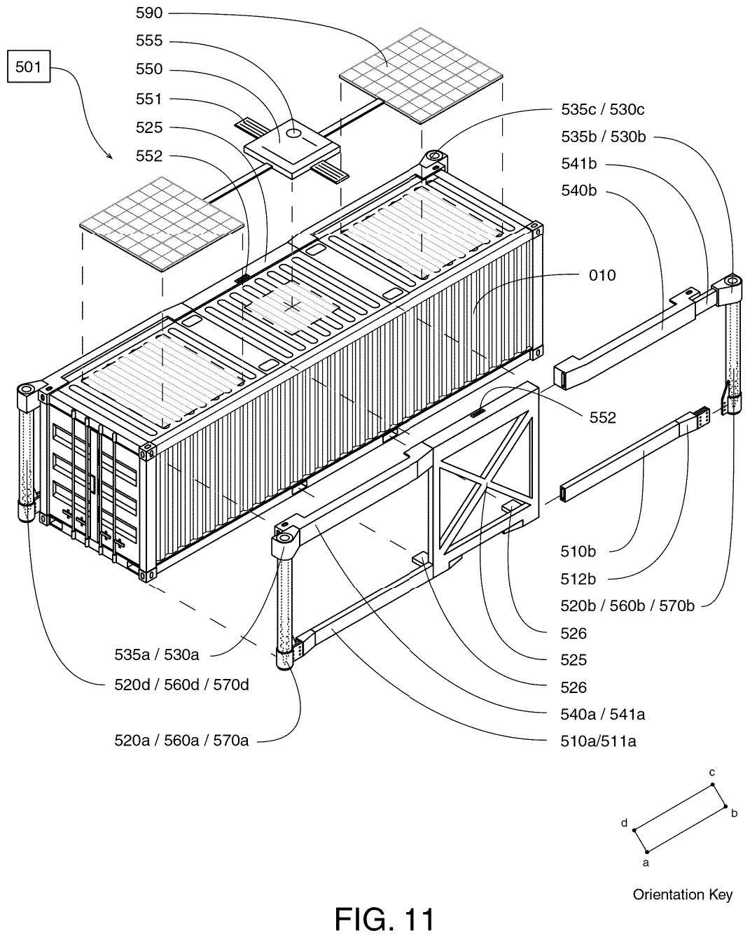

FIG. 11 is an Apparatus diagram illustrating embodiments of elements that are part of a RDR-SISL Kit (see 500, FIG. 9) in relation to a Payload Container 010 to elaborate on the structural assembly of components. The design of elements contemplate the intrinsic characteristics of a Payload Container embodiment to best leverage a Payload Container's structural members and fittings for RDR-SISL Kit attachment, such as undercarriage forklift pockets and corner castings at intersections of horizontal and vertical structural members. Other systems are illustrated in exploded isometric view to clearly illustrate part-to-whole relationships.

Element 512: is an attachment embodiment of a type of Lower Stabilization Arm Mechanical Attachment Clamp that can achieve a structural connection to a Telescoping Drilling/Leveling Actuator 520 assembly (and related sub-elements comprised of elements 560 and 570) that is tolerant of loading by means of plate actuation able to achieve a compressive clamp connection to a counterpart tab prepared with holes and slots that allow solid rods to pass through securing both vertical/horizontal registration and robust connection.

Element 526: is an attachment embodiment of a type of Forklift Pocket Connector for a Load Transfer Brace that facilitates a robust structural connection between the RDR-SISL Kit and the Payload Container 010. Element 526 exploits the forklift pocket, standardized on CONEX boxes, as a structural fastening point. The structural tab of 526 is dimensioned to fit this standard forklift pocket size.

Element 541: is an attachment embodiment of a type of Extension Segment of the Upper Positioning Arm assembly 540 that travels when the linear actuator function of the assembly operates. Element 541 functionally and structurally allows the spatial distribution of ground penetrating foundation elements to capture a larger area of ground within its perimeter than a Payload Container footprint alone otherwise achieves to enhance installation stability and resistance to lateral loads such as wind forces.

Element 551: is a generalized attachment embodiment of protective conduit within which to route power and data/communication cables.

Element 552: is a generalized attachment embodiment of a power and data/communications port that facilitates both pass-through continuous routing and plug/socket type connections for various types of cables with the connection standards they require. 552 includes the transfer shielding required to prevent destructive interference between power/data signal types conveyed by cables introduced.

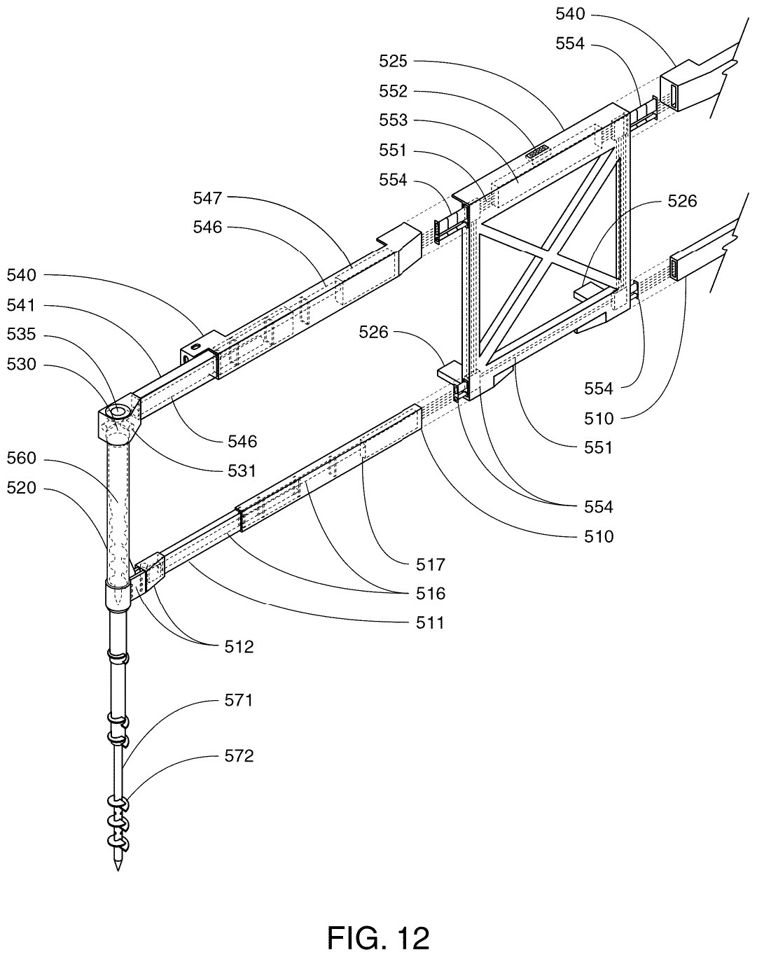

FIG. 12 is an Apparatus diagram illustrating representative parts of an attachment embodiment of a RDR-SISL Kit in greater detail.

Element 511: is an attachment embodiment of a type of Extension Segment of the Lower Stabilization Arm assembly 540 that travels when the linear actuator function of the assembly operates. Element 511 functionally and structurally allows the spatial distribution of ground penetrating foundation elements to capture a larger area of ground within its perimeter than a Payload Container footprint alone otherwise achieves to enhance installation stability and resistance to lateral loads such as wind forces.

Element 516: is an attachment embodiment of a type of Lower Linear Actuator that allows the Lower Stabilization Arm Extension Segment 511 to travel relative to the Lower Stabilization Arm 510. The torque and structural performance requirements of this Lower assembly differ from that of the Upper assembly.

Element 517: is an attachment embodiment of a type of Lower Motor to power the movement of the Lower Linear Actuator 516. The torque and structural performance requirements of this Lower assembly may differ from that of the Upper assembly.

Element 531: is an attachment embodiment of a type of Ball Joint Positioning Assembly that allows active mechanical manipulation of the angle of the Telescoping Drilling/Leveling Actuator 520 when passive alignment to the vector of gravity is not otherwise achieved, or when an angle that differs from the vector of gravity is required to satisfy deployment requirements.

Element 546: is an attachment embodiment of a type of Upper Linear Actuator that allows the Upper Positioning Arm Extension Segment 511 to travel relative to the Upper Positioning Arm 510. The torque and structural performance requirements of this Upper assembly may differ from that of the Lower assembly.

Element 547: is an attachment embodiment of a type of Upper Motor to power the movement of the Upper Linear Actuator 516. The torque and structural performance requirements of this Upper assembly may differ from that of the Lower assembly.

Element 553: is an attachment embodiment of a type of Battery Energy Storage System and Electrical Distribution Panel Assembly that is located within the Load Transfer Brace 525.

Element 554: is an attachment embodiment of a type of a plurality of Transfer Boxes that route electrical and data/communications cables to equipment external to the Load Transfer Brace 525.

Element 572: is an embodiment of a type Helical Bearing Plate which is attached in plurality to Augmented Foundation Piers 570. The design embodiments of 572 are specific to system performance requirements informed by design load, such as the helix angle, point flank, flute and land width, and distribution along the length of the pier shaft.

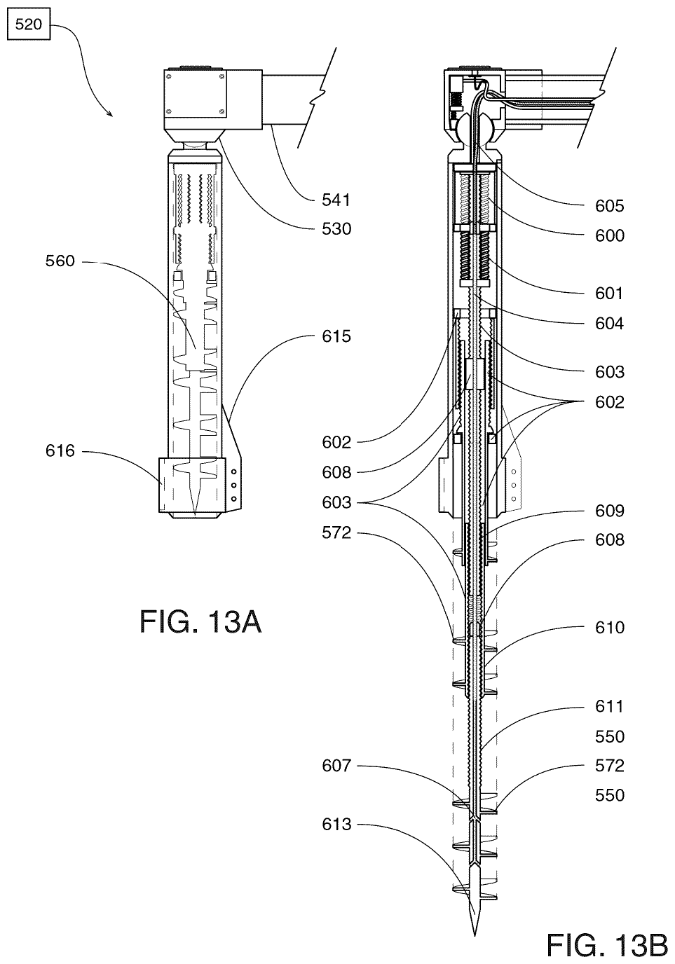

FIG. 13A is an Apparatus diagram illustrating an exterior view of an attachment embodiment of a Telescoping Drilling/Leveling Actuator 520 with its interior sub-elements shown in dashed outline representing the telescoping components in their shortest linear measurement configuration.

Element 615: is an embodiment of a type of structural Lower Stabilization Arm Mechanical Attachment Tab with holes and/or slots to receive the connection of a Mechanical Attachment Clamp 512.

Element 616: is an embodiment of a type of an embedded counterweight to the Lower Stabilization Arm Mechanical Attachment Tab to balance the center of gravity along the centerline of the Telescoping Drilling/Leveling Actuator 520 to neutralize any eccentric load introduced by the Attachment Tab 616.

FIG. 13B is an Apparatus sectional view diagram illustrating an attachment embodiment of a Telescoping Drilling/Leveling Actuator 520 and its sub-elements in a linear measurement configuration that is a multiple of their shortest measured length. The view shown was drawn to fit the page and is not representative a maximum length by either proportion or measure.

Element 600: is an embodiment of a type of Actuator Motor that will drive the composite Drilling/Leveling assembly of 520, 560 and 570 and their sub-elements.

Element 601: is an embodiment of a type of Planetary Roller Screw Actuator that will lengthen and/or shorten the total measured length of the composite Drilling/Leveling assembly of 520, 560 and 570. In lengthening, a corollary action is Drilling. In lengthening and shortening, a corollary action is Leveling dependent upon the actuator sub-assembly being manipulated.

Element 602: is an embodiment of a type of Telescoping Mechanism that leverages thread ratios, relationally fixed sleeves, barbs in keyed slots and defined range of motion to allow segmented portions of the assembly to extend from a minimum to maximum length with all intermediate points yielding an assembly that satisfies the structural performance specification relative to the total weight of an RDR-PC.

Element 603: is an embodiment of a general type of Threaded Pipe with a specified thread pitch, wall thickness, materiality and finish. The interior surface may either be threaded, keyed, or smooth.

Element 604: is an embodiment of a general type of full or partial Interior Canal in a rod or pipe to accommodate the passage of hardware, cables for power or data/comms, or liquid and/or slurry material.

Element 605: is an embodiment of a general type of channel that allows passage of hardware, cables for power or comms, or liquid and/or slurry material.

Element 607: is an embodiment of a general type of Canal and Port Nozzles suitable for the Distribution of grout delivered by a high-pressurized system.

Element 608: is an embodiment of a general type of Barb that allows the telescoping movement of an interior rod or pipe to travel at a different rate than an outer pipe while keeping the inner rod or pipe centered within the outer pipe and allow relational travel with minimal friction and non-destructive repeatability.

Element 609: is an embodiment of a type of Outer Pier Shaft is a prepared pipe that is outermost relative to all assembled pier shafts which telescope in the assembly.

Element 610: is an embodiment of a type of intermediate Pier Shaft is a prepared pipe that is one among a possible plurality of intermediate pier shafts relative to all assembled pier shafts which telescope in the assembly.

Element 611: is an embodiment of a type of Inner Pier Shaft is a prepared pipe that is innermost relative to all assembled pier shafts which telescope in the assembly.

Element 613: is an embodiment of a type of a Shaft Point as a sub-element of the Inner Pier Shaft 611.

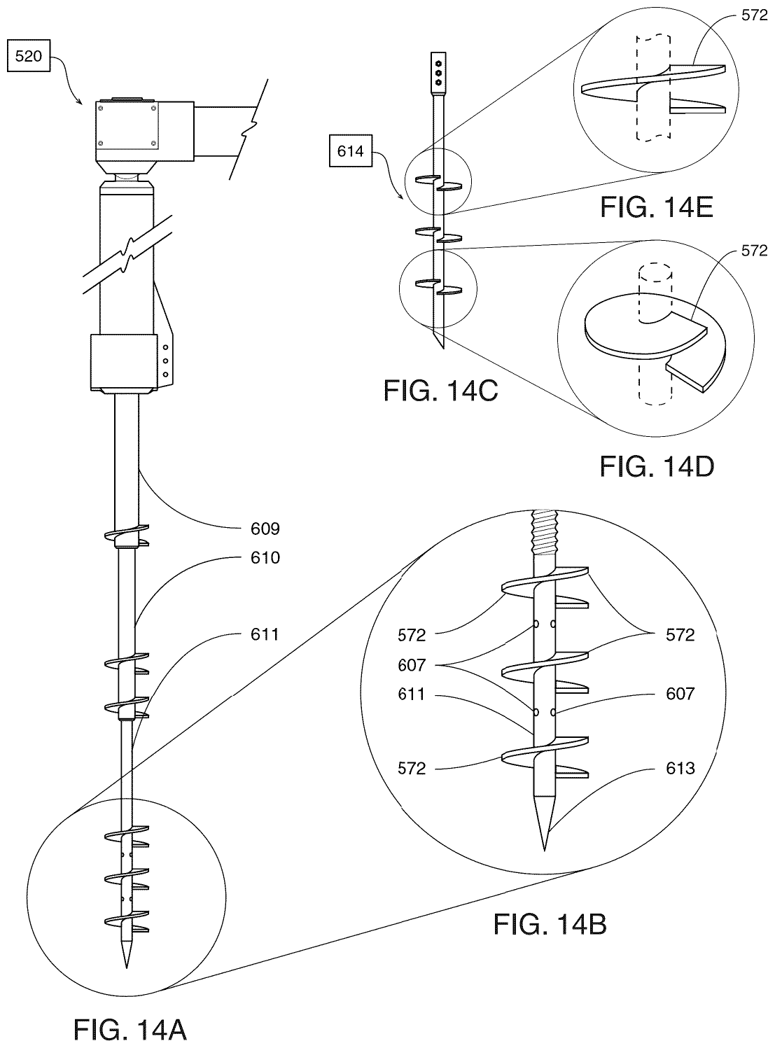

FIG. 14C, FIG. 14D, and FIG. 14E are Reference diagrams illustrating a commonplace helical pier segment as commonly available to illustrate how Helical Bearing Plates are affixed relative to the pier segment.

Element 614: is a typical Helical Pier Segment for provided for reference. No typical helical pier segments are part of this disclosure.

FIG. 14B is an Apparatus diagram with a magnified area illustrating an embodiment of an arrangement of elements at the Inner Pier Shaft 611. The magnification illustrates an embodiment of three Helical Pier Bearing Plates 572 attached to an Inner Pier Shaft. The Inner Pier Shaft 611 differs from that of a typical Helical Pier Segment in that it is prepared as part of a telescoping assembly rather than the additive assembly typical to commonplace Helical Pier Segments 614.

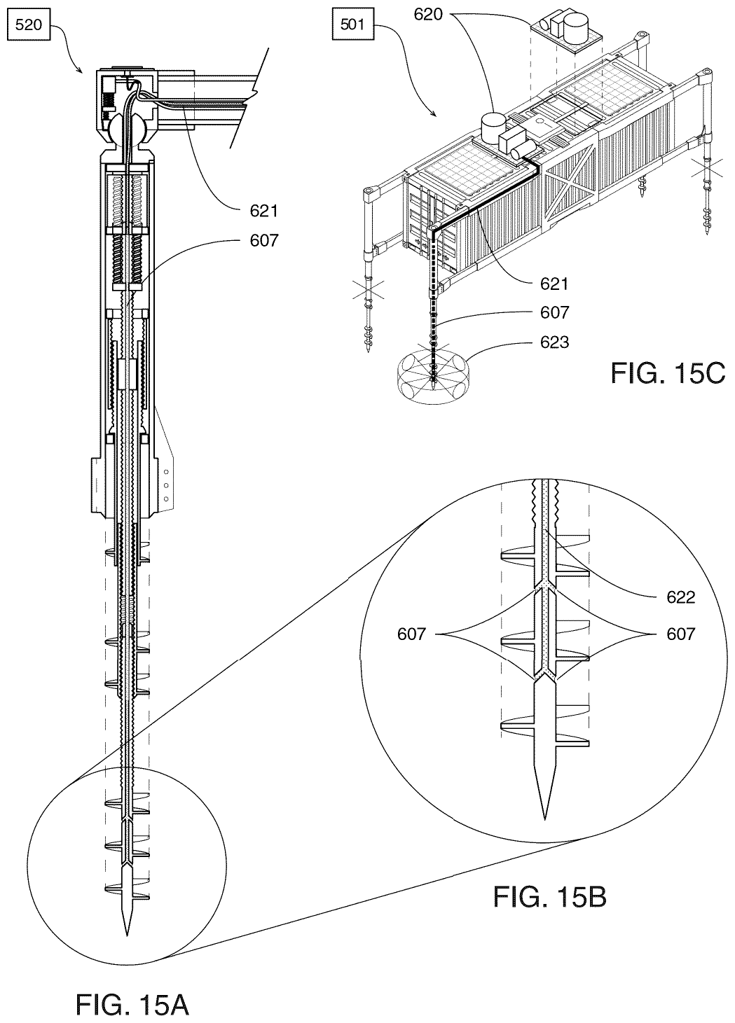

FIG. 15C is an Apparatus diagram illustrating an attachment embodiment of Modular Microjet Grouting System to an RDR-PC. A Microjet Grouting System allows an RDR-PC deployment to create site conditions for foundation pier bearing capacity where such conditions are otherwise lacking. The Telescoping Drilling/Leveling Actuator assembly 520/560/570 is driven to a maximum subgrade depth and introduces, by a high-pressure system 620, a grout bed mixture designed to harden in submersed environments. The Telescoping Drilling/Leveling Actuator assembly retracts to a margin clear of the grout bed for a calculated hardening period, then drives to meet/penetrate the grout bed to realize bearing capacity.

Element 620: is an embodiment of a type of Modular Microjet Grouting Plant with material storage, mixing, and high-pressure delivery services. The scale of projected site need determines the scale of the plant assembly.

Element 621: is an embodiment of a type of Grout Distribution Line that connects the Plant 620 to the Grout Canal and Port Nozzles 607 for subgrade introduction.

Element 622: is an embodiment of a type of Grout material mixture specified to suit hardening requirements in knowable substrate conditions.

Element 623: is a representation of the subgrade area the system is designed to be able to address with microjet grout introduction. The result creates a plate-like shelf of hardened material upon which distribute the point load of a pier to an area substantially broader in diameter.

FIG. 15A and FIG. 15B are Apparatus diagrams illustrating a magnified view of an embodiment of an Inner Pier Shaft element 611 with the relative location of Grout Canal and Port Nozzles 607.

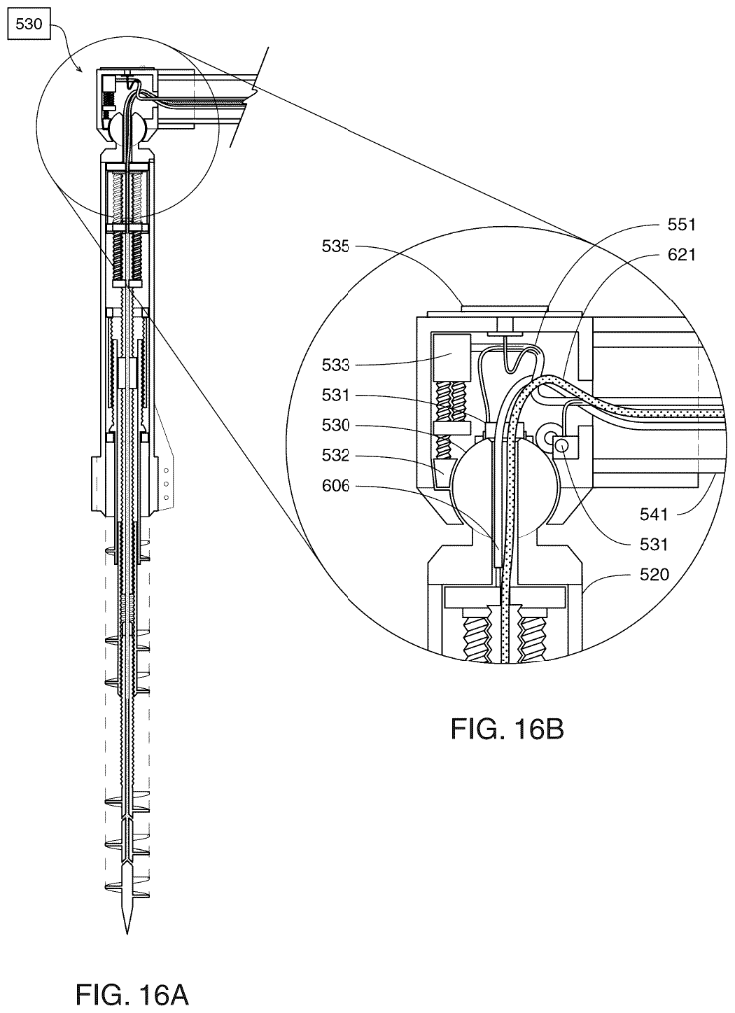

FIG. 16A and FIG. 16B areApparatus diagrams illustrating an embodiment of a Range-Limited Ball Joint 530 that facilitates the positioning of the Telescoping Drilling/Leveling Actuator located below the ball joint. The magnified area of the illustration shows the housing in sectional view. The Ball Joint is a lubricated system and as such is gasketed sufficiently for extreme weather environments to maintain lubrication through the term of deployment. The Ball Joint housing includes instruments, equipment and hardware that arerelated to positioning and alignment which are described in the element elaboration below.

Element 532: is an embodiment of a type of Ball Joint Braking Assembly that is controlled by an actuator that varies the friction pressure applied to the ball joint via a convex spherical brake pad(s) with a prepared friction surface.

Element 533: is an embodiment of a type of Ball Joint Braking Actuator that varies the braking pressure applied to the ball joint in small enough increments to permit controlled spherical rotation and sufficient pressure to lock in Ball Joint position under the load until the Lower Stabilization Arms 510 mechanically re-connect to the Telescoping Drilling/Levelling Actuator 520 to form a rigid frame, thus reducing the structural demand on the Ball Joint Braking Assembly.

Element 606: is an embodiment of a kind of Power Cable able to be routed through the assembly for connection to device power ports.

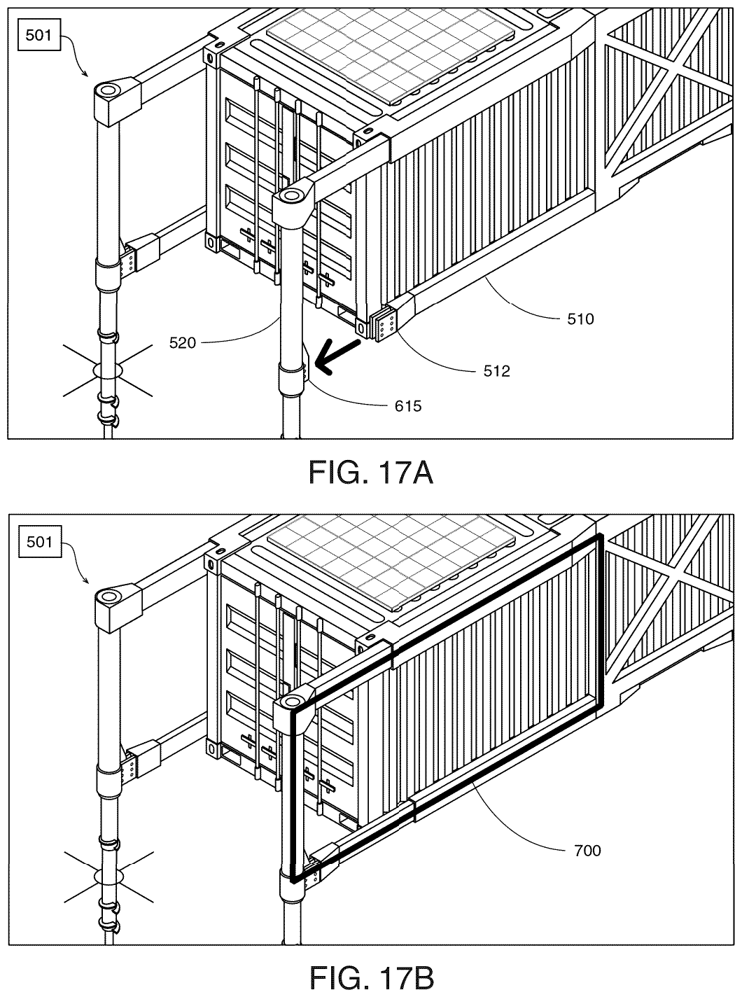

FIG. 17A is an Apparatus diagram illustrating an attachment embodiment of an RDR-PC 501 with a retracted Lower Stabilization Arm 510 with disengaged Lower Stabilization Arm Mechanical Attachment Clamp 512. The Illustration shows the clamp's counterpart Attachment Tab 615 which is utilized to stabilize the Telescoping Drilling/Leveling Actuator 520 when engaged. The arrow symbol indicated the direction of Lower Stabilization Arm linear actuation necessary to complete a structural frame.

FIG. 17B is an Apparatus diagram illustrating an attachment embodiment of an RDR-PC 501 with a attached Lower Stabilization Arm 510 with Lower Stabilization Arm Mechanical Attachment Clamp 512 engaged to its counterpart Attachment Tab 615. The mechanical connection yields a Structural Frame 700 that resists bending and shear ddeformation.

Element 700: is a diagram of a structural frame that resists bending and transformation due in part to the RDR-SISL Kit 500 attachment to a Payload Container 010 with its own intrinsic shear resistance, and to the abutment to the Load Transfer Brace 525.

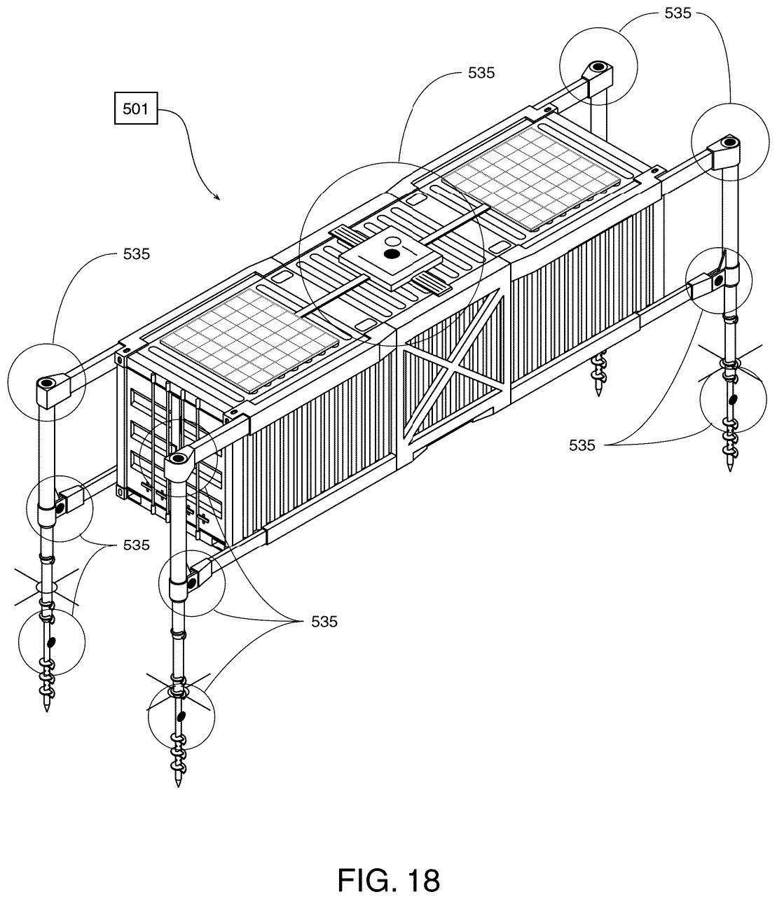

FIG. 18 is an Apparatus diagram illustrating an attachment embodiment distribution of Sensor Stacks 535 which report data to the DAPU 550.

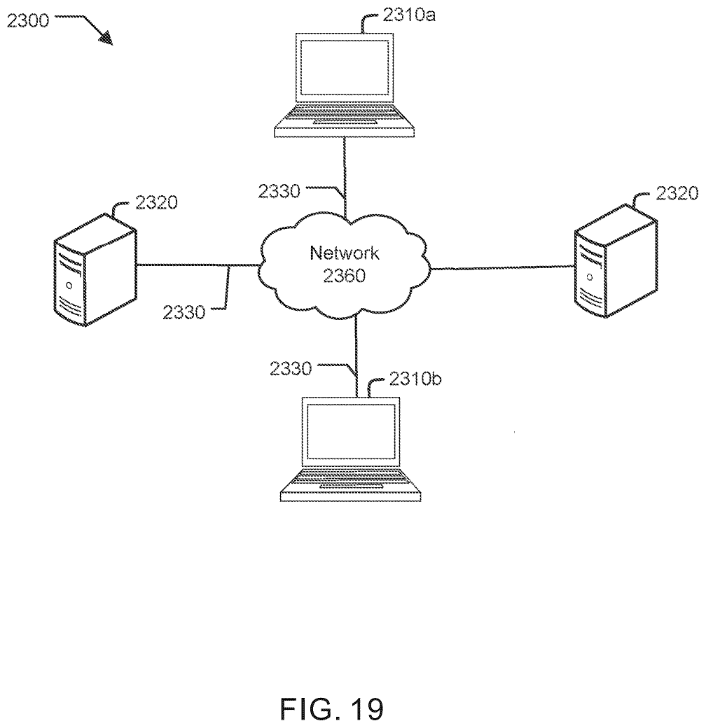

FIG. 19 is an exemplary block diagram depicting an embodiment of a system for implementing embodiments of methods of the disclosure; and

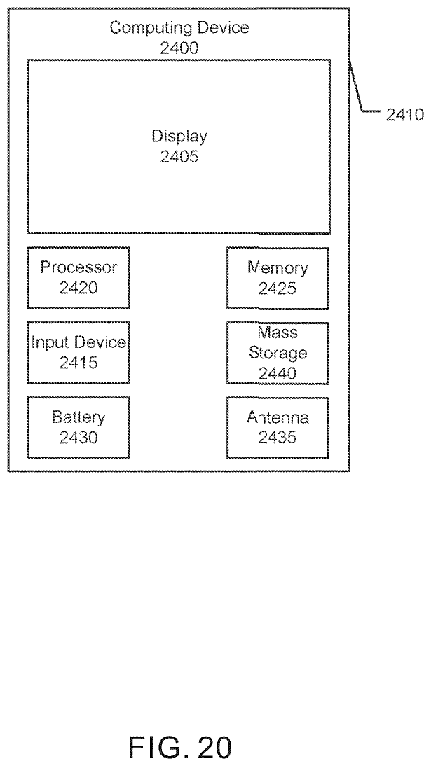

FIG. 20 is an exemplary block diagram depicting a computing device.

FIG. 19 is an exemplary block diagram depicting an embodiment of system 115 for implementing embodiments of methods of the disclosure, e.g., as described with reference to the previous figures, and particularly elements 300, 310, 450, 455, and 550.

In FIG. 19, computer network 2300 includes a number of computing devices 2310a-2310b (each of which may implement element 115), and one or more server systems 2320 coupled to a communication network 2360 via a plurality of communication links 2330. Communication network 2360 provides a mechanism for allowing the various components of distributed network 2300 to communicate and exchange information with each other. Thus, FIG. 19 describes systems for implementing elements, e.g., 300, 310, 450, 455, 550, and communications among them and with elements, e.g., sensor stacks 435, 535, of the embodiments.

Communication network 2360 itself is comprised of one or more interconnected computer systems and communication links. Communication links 2330 may include hardwire links, optical links, satellite or other wireless communications links, wave propagation links, or any other mechanisms for communication of information. Various communication protocols may be used to facilitate communication between the various systems shown in FIG. 19. These communication protocols may include TCP/IP, UDP, HTTP protocols, wireless application protocol (WAP), BLUETOOTH, Zigbee, 802.11, 802.15, 6LoWPAN, LiFi, Google Weave, NFC, GSM, CDMA, other cellular data communication protocols, wireless telephony protocols, Internet telephony, IP telephony, digital voice, voice over broadband (VoBB), broadband telephony, Voice over IP (VOIP), vendor-specific protocols, customized protocols, and others. While in one embodiment, communication network 2360 is the Internet, in other embodiments, communication network 2360 may be any suitable communication network including a local area network (LAN), a wide area network (WAN), a wireless network, a cellular network, a personal area network, an intranet, a private network, a near field communications (NFC) network, a public network, a switched network, a peer-to-peer network, and combinations of these, and the like.

In an embodiment, the server 2320 is not located near a user of a computing device, and is communicated with over a network. In a different embodiment, the server 2320 is a device that a user can carry upon his person, or can keep nearby. In an embodiment, the server 2320 has a large battery to power long distance communications networks such as a cell network (LTE, 5G), or Wi-Fi. The server 2320 communicates with the other components of the system via wired links or via low powered short-range wireless communications such as Bluetooth®. In an embodiment, one of the other components of the system plays the role of the server, e.g., the PC 2310b.

Distributed computer network 2300 in FIG. 19 is merely illustrative of an embodiment incorporating the embodiments and does not limit the scope of the invention as recited in the claims. One of ordinary skill in the art would recognize other variations, modifications, and alternatives. For example, more than one server system 2320 may be connected to communication network 2360. As another example, a number of computing devices 2310a-2310b may be coupled to communication network 2360 via an access provider (not shown) or via some other server system.

Computing devices 2310a-2310b typically request information from a server system that provides the information. Server systems by definition typically have more computing and storage capacity than these computing devices, which are often such things as portable devices, mobile communications devices, or other computing devices that play the role of a client in a client-server operation. However, a particular computing device may act as both a client and a server depending on whether the computing device is requesting or providing information. Aspects of the embodiments may be embodied using a client-server environment or a cloud-cloud computing environment.

Server 2320 is responsible for receiving information requests from computing devices 2310a-2310b, for performing processing required to satisfy the requests, and for forwarding the results corresponding to the requests back to the requesting computing device. The processing required to satisfy the request may be performed by server system 2320 or may alternatively be delegated to other servers connected to communication network 2360 or to other communications networks. A server 2320 may be located near the computing devices 2310 or may be remote from the computing devices 2310. A server 2320 may be a hub controlling a local enclave of things in an internet of things scenario.

Computing devices 2310a-2310b enable users to access and query information or applications stored by server system 2320. Some example computing devices include portable electronic devices (e.g., mobile communications devices) such as the Apple iPhone®, the Apple iPad®, the Palm Pre™, or any computing device running the Apple iOS™, Android™ OS, Google Chrome OS, Symbian OS®, Windows 10, Windows Mobile® OS, Palm OS® or Palm Web OS™, or any of various operating systems used for Internet of Things (IoT) devices or automotive or other vehicles or Real Time Operating Systems (RTOS), such as the RIOT OS, Windows 10 for loT, WindRiver VxWorks, Google Brillo, ARM Mbed OS, Embedded Apple iOS and OS X, the Nucleus RTOS, Green Hills Integrity, or Contiki, or any of various Programmable Logic Controller (PLC) or Programmable Automation Controller (PAC) operating systems such as Microware OS-9, VxWorks, QNX Neutrino, FreeRTOS, Micrium μC/OS-11, Micrium μC/OS-III, Windows CE, TI-RTOS, RTEMS. Other operating systems may be used. In a specific embodiment, a “web browser” application executing on a computing device enables users to select, access, retrieve, or query information and/or applications stored by server system 2320. Examples of web browsers include the Android browser provided by Google, the Safari® browser provided by Apple, the Opera Web browser provided by Opera Software, the BlackBerry® browser provided by Research In Motion, the Internet Explorer® and Internet Explorer Mobile browsers provided by Microsoft Corporation, the Firefox® and Firefox for Mobile browsers provided by Mozilla®, and others.

FIG. 20 is an exemplary block diagram depicting a computing device 2400 of an embodiment. Computing device 2400 may be any of the computing devices 2310 from FIG. 19. Computing device 2400 may include a display, screen, or monitor 2405, housing 2410, and input device 2415. Housing 2410 houses familiar computer components, some of which are not shown, such as a processor 2420, memory 2425, battery 2430, speaker, transceiver, antenna 2435, microphone, ports, jacks, connectors, camera, input/output (1/0) controller, display adapter, network interface, mass storage devices 2440, various sensors, and the like.

Input device 2415 may also include a touchscreen (e.g., resistive, surface acoustic wave, capacitive sensing, infrared, optical imaging, dispersive signal, or acoustic pulse recognition), keyboard (e.g., electronic keyboard or physical keyboard), buttons, switches, stylus, or combinations of these.

Mass storage devices 2440 may include flash and other nonvolatile solid-state storage or solid-state drive (SSD), such as a flash drive, flash memory, or USB flash drive. Other examples of mass storage include mass disk drives, floppy disks, magnetic disks, optical disks, magneto-optical disks, fixed disks, hard disks, SD cards, CD-ROMs, recordable CDs, DVDs, recordable DVDs (e.g., DVD-R, DVD+R, DVD-RW, DVD+RW, HD-DVD, or Blu-ray Disc), battery-backed-up volatile memory, tape storage, reader, and other similar media, and combinations of these.
Embodiments may also be used with computer systems having different configurations, e.g., with additional or fewer subsystems, and may include systems provided by Arduino, or Raspberry Pi. For example, a computer system could include more than one processor (i.e., a multiprocessor system, which may permit parallel processing of information) or a system may include a cache memory. The computer system shown in FIG. 20 is but an example of a computer system suitable for use with the embodiments. Other configurations of subsystems suitable for use with the embodiments will be readily apparent to one of ordinary skill in the art. For example, in a specific implementation, the computing device is a mobile communications device such as a smartphone or tablet computer. Some specific examples of smartphones include the Droid Incredible and Google Nexus One, provided by HTC Corporation, the iPhone or iPad, both provided by Apple, and many others. The computing device may be a laptop or a netbook. In another specific implementation, the computing device is a non-portable computing device such as a desktop computer or workstation.

A computer-implemented or computer-executable version of the program instructions useful to practice the embodiments may be embodied using, stored on, or associated with computer-readable medium. A computer-readable medium may include any medium that participates in providing instructions to one or more processors for execution, such as memory 2425 or mass storage 2440. Such a medium may take many forms including, but not limited to, nonvolatile, volatile, transmission, non-printed, and printed media. Nonvolatile media includes, for example, flash memory, or optical or magnetic disks. Volatile media includes static or dynamic memory, such as cache memory or RAM. Transmission media includes coaxial cables, copper wire, fiber optic lines, and wires arranged in a bus. Transmission media can also take the form of electromagnetic, radio frequency, acoustic, or light waves, such as those generated during radio wave and infrared data communications.

For example, a binary, machine-executable version, of the software useful to practice the embodiments may be stored or reside in RAM or cache memory, or on mass storage device 2440. The source code of this software may also be stored or reside on mass storage device 2440 (e.g., flash drive, hard disk, magnetic disk, tape, or CD-ROM). As a further example, code useful for practicing the embodiments may be transmitted via wires, radio waves, or through a network such as the Internet. In another specific embodiment, a computer program product including a variety of software program code to implement features of the embodiment is provided.

The following paragraphs set forth enumerated embodiments.
Embodiment 1 is to a method comprising: autonomously, semi-autonomously and/or by remotely controlled installation of a Payload Structure at a build site where no prior site preparation is possible or efficiently achieved.
Embodiment 2 is to embodiment 1 or any other embodiment, wherein: data acquisition and robotic systems act in coordination to allow an installation to be achieved autonomously, semi-autonomously and/or by remotely controlled means.
Embodiment 3 is to a system comprising: a robotic system of sub-systems and parts that can be attached to, or integrated within, a variety of Payload Structures to achieve foundation installation, leveling of structure, and continuous level monitoring and correction thereafter.
Embodiment 4 is to a system comprising: a complete, or partial, frame that attaches to any payload object (of any form factor standard, or non-standard: square, rectangular, cylindrical, non-orthogonal poly-sided) that works mechanically/robotically and is driven by proprietary software to self-install and self-level the payload object.
Embodiment 5 is to an exo-structural apparatus to be used for self-installation and self-leveling of a payload container, such as shipping container (without being limited to the form factor of a shipping container), which, when attached thereto, completes structural performance by contemplating the maximum payload weight tolerated by the shipping container.
Embodiment 6 is to a method comprising: the installation, mission level establishment, mission level maintenance, and de-installation of a payload container by robotic means at deployment sites deemed unsuitable for conventional construction methods and their results, such as: sites where the conventionally required practices of site clearance, grading, and/or soils compaction are either impossible, difficult, or cost/labor inefficient to achieve as advance preparation for payload container deployment on a particular build site; and sites that are vulnerable to erosion and/or differential settlement which may threaten the intended operational longevity of a conventionally deployed payload container unable to adapt to site changes of this kind, and where “mission level” refers to the target 3-dimensional position of the payload container as an object in 3-dimensional space. The mission level may be either perpendicular to the vector of gravity (so that a steel marble does not roll when placed in the true center of the payload container interior floor plane), or eccentric (intentionally sloped, so that it does roll) based on operational requirements of the payload.
Embodiment 7 is to the method of embodiment 6, or any other embodiment, wherein: hardware and software provide a Rapid Deployment Robotic Self-Installing and Self-Leveling of Payload Containers (“RDR-PC”) method and system for site installing a payload container, by outfitting the payload container with component drilling/driving actuator assemblies, and, through the action of introducing foundation elements into the site substrate to a depth, or condition, that achieves sufficient bearing capacity to support a share of the weight of a payload container, wherein, the reverse of the same method can be used to de-install the payload container for removal from the build site at end-of-mission.
Embodiment 8 is to the method of embodiment 6, or any other embodiment, wherein: hardware and software provide an RDR-PC system and method for setting the mission level position of a payload container on a build site through the action of manipulating the payload container's position in three-dimensional space through relative adjustment of multiple sensor-rigged RDR-PC component drilling/driving actuator assemblies (each with separately addressable x, y, and z targets) which share in the distribution of the payload container's load relative to installed foundation and the same method of adjustment may be used to restore degraded mission level position throughout the deployment lifecycle or to return a payload container to its optimal de-install position (e.g., by the method of embodiment 9).
Embodiment 9 is to the method of embodiment 6, or any other embodiment, wherein: hardware and software provide an RDR-PC system and method for maintaining payload container mission level, after once initially established (e.g., by the method of embodiment 8), throughout the term of deployment lifecycle, where the method involves timed-interval monitoring of multiple distributed sensors that report on a payload container's current state x, y, and z positions and log the same in a time-stamped data set file for comparison to the originally established mission level x, y, and z position master data set and non-equivalency deviation is flagged as a settlement trend that is then processed by A.I.-reconciled algorithms to determine the best robotic process solution to restoring a payload container to its original mission level position (or a relational equivalent, if only an elevational offset is determined to be achievable) in consideration of additional data inputs which may impact the efficacy of a process of correction, wherein such additional data sets considered by the A.I.-reconciled algorithms to model both the settlement trend forecast and the best scenario for A.I.-timed correction intervention include, but are not limited to, locally acquired sensor-based inputs such as: temperature, moisture, freeze/thaw state, and/or additional remotely acquired predictive data inputs from external sources such as weather data.
Embodiment 10 is to the method of embodiment 6, or any other embodiment, wherein: hardware, software and communications systems comprise an RDR-PC method of facilitating installation, mission level establishment, mission level maintenance, and de-installation of payload container(s) by selectable autonomous, semi-autonomous, and/or by remote controlled means based on the requirements, or limitations, of the deployment and individual phase of operation (e.g., allowing the remote controlled installation phase of a payload container deployment to be remote controlled and, thereafter, for mission level maintenance to be performed autonomously (or inversely, or any combination thereof).
Embodiment 11 is to the method of embodiment 6, or any other embodiment, wherein: a helical pier system is combined with a Telescoping Drilling/Leveling Actuator (i.e., an actuator adapted to extend to a total length that is a multiple of its length in a closed/collapsed/overlapping position) into an RDR-PC Telescoping Drilling/Leveling Actuator, where, with this combined assembly, drilling, extending a foundation element to target depth, and establishing/maintaining mission level position of the payload container are all accomplished with the same combined RDR-PC component drilling/driving actuator assembly.
Embodiment 12 is to the method of embodiment 6, or any other embodiment, wherein: a microjet grouting system is integrated into an RDR-PC Telescoping Drilling/Leveling Actuator assembly to allow the driven helical pier to channel high-pressure delivered grout through the helical pier element for injection into the target foundation zone of a substrate to create subsurface bearing capacity when found conditions are inadequate to bear the weight of the deployed payload container outfitted with an RDR-PC kit comprising the non-payload container components of the RDR-PC system.
Embodiment 13 is to the method of embodiment 6, or any other embodiment, including variable one-way braking control for an RDR-PC component drilling/driving actuator assembly to address eccentrically distributed payloads within the payload container and/or to accommodate differing gravity conditions (e.g., off-world deployments) so that downward adjustment to a target position does not allow load acceleration under the weight of the payload container to disrupt precision positioning, while upward adjustment to a target position is remains unimpeded.
Embodiment 14 is to the method of embodiment 6, or any other embodiment, wherein: a mechanical connection allows an RDR-PC Telescoping Drilling/Leveling Actuator assembly freedom of movement in a range-limited ball joint to achieve gravity alignment (i.e., falling in a direction consistent with the vector gravity) that can bear a share of the maximum weight of the payload container, plus a margin for peak forces (in excess of mere weight) created during RDR-PC drilling/driving and leveling processes, where this range-limited ball joint includes a system-driven friction adjustment to lock the ball joint in place during transit and upon installation completion, and where, once the payload container has been positioned at mission level position, stabilizing arm actuators extend to lock the drilling/driving actuator assemblies in place as a double measure to both backstop the friction limiting of the ball joint's range of motion and to complete a functioning structural moment frame.
Embodiment 15 is to a system comprising: an RDR-PC kit itself including a robotic system of sub-systems and parts that can be combined with a payload container to enhance a payload container's field deployment versatility with autonomous, semi-autonomous, or remote controlled spatial/mechanical manipulation functions that are relevant to site installation, lifecycle maintenance, and/or end-of-mission removal such as (but not limited to): robotic foundation installation, robotic foundation connection, robotic mission level establishment, robotic mission level maintenance (monitoring and correction), and eventual robotic de-installation on deployment sites where limited access, high difficulty, or present/projected climate change impacts make prior site preparation (such as site clearance, grading, and/or soils compaction) and forward-going on-site facilities management staffing impossible or inefficiently achieved.
Embodiment 16 is to the system of embodiment 15 or any other embodiment, wherein: the robotic/mechanical manipulation functions of the RDR-PC kit are designed for attachment to a Payload Container (which may vary in form-factor) and where the RDR-PC kit size and weight are minimized by being designed to take advantage of the Payload Container to gain structural efficiency by exploiting a Payload Container's inherent structural performance, and in some cases, augmenting it, to satisfy the structural requirements of the RDR-PC kit performance relative to the Payload Container such that the RCR-PC kit is adapted for connecting to existing Payload Containers for adaptive retrofit and/or RDR-PC kit interchangeability.
Embodiment 17 is to the system of embodiment 15 or any other embodiment, wherein: the robotic/mechanical manipulation functions of the RDR-PC kit are fully integrated into a Payload Container's design (which may vary in form-factor), thus modifying a Payload Container's standardized design to be produced as a new integrated, such that the RDR-PC system achieves the highest degree of materials and structural engineering efficiency but excludes interchangeability and retrofit of prior built Payload Containers due to its inseparability, and where form factors include forms typically produced or standardized by others; including, but not limited to, volumetric containers such as: CONEX box (a “container, express” commonly called a “shipping container”), regular 6-sided rectilinear, spherical, cylindrical, or regular/irregular poly-sided volumetric self-supporting structural containers, etc.
Embodiment 18 is to a method for the field installation of a payload container comprising:
   (a) installing said payload container on a deployment site via one or more robotic actuator assemblies without prior site clearance, grading, or soil compaction; and
   (b) establishing a defined three-dimensional mission level position of said payload container using sensor-instrumented robotic means, wherein said mission level position is defined by a target spatial orientation that is either orthogonal to gravity or non-orthogonal based on application-specific operational criteria.
Embodiment 19 is to embodiment 18 or any other embodiment, wherein each actuator assembly includes a telescoping mechanism configured to extend to a multiple of its collapsed length, for simultaneous drilling and elevation control.
Embodiment 20 is to embodiment 18 or any other embodiment 3, wherein said robotic actuator assemblies are configured to include helical pier foundation elements for introduction into the site substrate to a depth or soil condition sufficient to support the static and dynamic loads of the payload container.
Embodiment 21 is to embodiment 18 or any other embodiment, wherein each actuator assembly comprises independently addressable x-, y-, and z-axis targets for localized adjustment, enabling spatial manipulation of the payload container to achieve mission level.
Embodiment 22 is to embodiment 18 or any other embodiment, wherein the robotic system includes a selectable control interface allowing mode-switching between autonomous, semi-autonomous, and remote-controlled operation during different deployment phases.
Embodiment 23 is to embodiment 18 or any other embodiment, wherein at least one actuator assembly is configured to inject grout into the substrate through an internal high-pressure microjet grouting system to reinforce bearing capacity in substrates with inadequate load characteristics.
Embodiment 24 is to embodiment 18 or any other embodiment, wherein each actuator assembly is mechanically coupled to the payload container via a ball joint with a friction-locking mechanism, said joint permitting limited range of motion, yet within that range, free to fall orthogonal to the vector of gravity during deployment and being further stabilized by deployable armature actuators to form a rigid structural moment frame upon mission-level attainment.
Embodiment 25 is to embodiment 18 or any other embodiment, further including:
   (c) maintaining said mission level position during the operational lifecycle through sensor monitoring and automated or remote-controlled corrective actions.
Embodiment 26 is to embodiment 25 or any other embodiment, further comprising monitoring of said mission level via time-stamped data sets produced by said sensors, wherein deviations from original positional data are algorithmically analyzed to trigger corrective actuation to maintain mission level.
Embodiment 27 is to embodiment 25 or any other embodiment, further including:
   (d) de-installing said payload container by reversing the robotic installation process, wherein the installing said payload container on a deployment site via one or more robotic actuator assemblies is performed without prior site clearance, grading, or soil compaction.
Embodiment 28 is to a kit configured to be attached to or integrated with a payload container such that, when the kit is attached or integrated with the payload container, the kit and payload container form a system configured for autonomous, semi-autonomous or remote-controlled deployment of the payload container, the kit comprising:
   (a) a plurality of telescoping drilling/driving actuator assemblies;
   (b) an array of orientation and environmental sensors;
   (c) a control unit provided with closed-loop feedback control capability of the actuator assemblies; and
   (d) a control interface and communications systems for autonomous, semi-autonomous, or remote-controlled operation, wherein said system is configured to execute robotic installation and mission-level positioning of the payload container; and, optionally, one or more of:
   a photo-voltaic system and associated battery energy storage system to power installation, monitoring and maintenance, and de-installation processes;
   a microjet grouting system; or
   structural augmentation of the payload container to support the functions of the kit relative to the payload container.
Embodiment 29 is to embodiment 28 or any other embodiment, wherein the kit is modularly attachable to pre-existing payload containers selected from a group including: rectilinear, cylindrical, spherical, and irregular polyhedral enclosures.
Embodiment 30 is to embodiment 28 or any other embodiment, wherein the kit is fully integrated into a purpose-designed payload container chassis, the container being engineered to structurally complement the system and thereby maximize performance.
Embodiment 31 is to embodiment 28 or any other embodiment, wherein said system is configured to execute continuous settlement monitoring and correction.
Embodiment 32 is to embodiment 31 or any other embodiment, wherein: said system is configured to execute robotic installation and mission-level positioning of the payload container in terrain lacking conventional preparation; and said system is configured to execute de-installation of said payload container.
Embodiment 33 is to a system configured for autonomous, semi-autonomous, or remote-controlled deployment of a payload container, comprising:
   (a) a payload container;
   (b) a plurality of telescoping drilling/driving actuator assemblies;
   (c) an array of orientation and environmental sensors;
   (d) a control unit provided with closed-loop feedback control capability of the actuator assemblies;
   (e) a control interface and communications systems for autonomous, semi-autonomous, or remote-controlled operation, wherein said system is configured to execute robotic installation and mission-level positioning of the payload container; and, optionally, one or more of: (f) a photo-voltaic system and associated battery energy storage system to power installation, monitoring and maintenance, and de-installation processes; or (g) a microjet grouting system.
Embodiment 34 is to embodiment 33, or any other embodiment, wherein the payload container is one of: a rectilinear, a cylindrical, a spherical, or an irregular polyhedral container.
Embodiment 35 is to embodiment 33, or any other embodiment, wherein the plurality of telescoping drilling/driving actuator assemblies; the array of orientation and environmental sensors; the control unit; and the control interface (etc. see e, f and g above) are fully integrated into a purpose-designed payload container chassis, the container chassis being engineered to structurally complement the system and thereby maximize efficiency and performance.
Embodiment 36 is to embodiment 33, or any other embodiment, wherein said system is configured to execute continuous settlement monitoring and correction.
Embodiment 37 is to embodiment 36, or any other embodiment, wherein: said system is configured to execute robotic installation and mission-level positioning of the payload container in terrain lacking conventional preparation; and said system is configured to execute de-installation of said payload container.

While the embodiments have been described with regards to particular embodiments, it is recognized that additional variations may be devised without departing from the inventive concept.

The terminology used herein is for the purpose of describing particular embodiments only and is not intended to be limiting of the claimed subject matter. As used herein, the term “and/or” includes any and all combinations of one or more of the associated listed items. As used herein, the singular forms “a,” “an,” and “the” are intended to include the plural forms as well as the singular forms, unless the context clearly indicates otherwise. It will further be understood that the terms “comprises” and/or “comprising,” when used in this specification, specify the presence of states features, steps, operations, elements, and/or components, but do not preclude the present or addition of one or more other features, steps, operations, elements, components, and/or groups thereof.

Unless otherwise defined, all terms (including technical and scientific terms) used herein have the same meaning as commonly understood by one having ordinary skill in the art to which the embodiments belong. It will further be understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

In describing the embodiments, it will be understood that a number of elements, techniques, and steps are disclosed. Each of these has individual benefit and each can also be used in conjunction with one or more, or in some cases all, of the other disclosed elements, or techniques. The specification and claims should be read with the understanding that such combinations are entirely within the scope of the embodiments and the claimed subject matter.

In the description above and throughout, numerous specific details are set forth in order to provide a thorough understanding of an embodiment of this disclosure. It will be evident, however, to one of ordinary skill in the art, that an embodiment may be practiced without these specific details. In other instances, well-known structures and devices are shown in block diagram form to facilitate explanation. The description of the preferred embodiments is not intended to limit the scope of the claims appended hereto. Further, in the methods disclosed herein, various steps are disclosed illustrating some of the functions of an embodiment. These steps are merely examples and are not meant to be limiting in any way. Other steps and functions may be contemplated without departing from this disclosure or the scope of an embodiment.

What is claimed is:

1. A method for the field installation of a payload container comprising:
(a) installing said payload container on a deployment site via one or more robotic actuator assemblies without prior site clearance, grading, or soil compaction; and
(b) establishing a defined three-dimensional mission level position of said payload container using sensor-instrumented robotic means, wherein said mission level position is defined by a target spatial orientation that is either orthogonal to gravity or non-orthogonal based on application-specific operational criteria.

2. The method of claim 1, wherein each actuator assembly includes a telescoping mechanism configured to extend to a multiple of its collapsed length, for simultaneous drilling and elevation control.

3. The method of claim 1, wherein said robotic actuator assemblies are configured to include helical pier foundation elements for introduction into the site substrate to a depth or soil condition sufficient to support the static and dynamic loads of the payload container.

4. The method of claim 1, wherein each actuator assembly comprises independently addressable X-, y-, and z-axis targets for localized adjustment, enabling spatial manipulation of the payload container to achieve mission level.

5. The method of claim 1, wherein the robotic system includes a selectable control interface allowing mode-switching between autonomous, semi-autonomous, and remote-controlled operation during different deployment phases.

6. The method of claim 1, wherein at least one actuator assembly is configured to inject grout into the substrate through an internal high-pressure microjet grouting system to reinforce bearing capacity in substrates with inadequate load characteristics.

7. The method of claim 1, wherein each actuator assembly is mechanically coupled to the payload container via a ball joint with a friction-locking mechanism, said joint permitting limited range of motion, yet within that range, free to fall orthogonal to the vector of gravity during deployment and being further stabilized by deployable armature actuators to form a rigid structural moment frame upon mission-level attainment.

8. The method of claim 1 further including:
(c) maintaining said mission level position during the operational lifecycle through sensor monitoring and automated or remote-controlled corrective actions.

9. The method of claim 8, further comprising monitoring of said mission level via time-stamped data sets produced by said sensors, wherein deviations from original positional data are algorithmically analyzed to trigger corrective actuation to maintain mission level.

10. The method of claim 8, further including:
(d) de-installing said payload container by reversing the robotic installation process, wherein the installing said payload container on a deployment site via one or more robotic actuator assemblies is performed without prior site clearance, grading, or soil compaction.

11. A kit configured to be attached to or integrated with a payload container such that, when the kit is attached or integrated with the payload container, the kit and payload container form a system configured for autonomous, semi-autonomous or remote-controlled deployment of the payload container, the kit comprising:
(a) a plurality of telescoping drilling/driving actuator assemblies;
(b) an array of orientation and environmental sensors;
(c) a control unit provided with closed-loop feedback control capability of the actuator assemblies; and
(d) a control interface and communications systems for autonomous, semi-autonomous, or remote-controlled operation, wherein said system is configured to execute robotic installation and mission-level positioning of the payload container.

12. The kit of claim 11, wherein the kit is modularly attachable to pre-existing payload containers selected from a group including: rectilinear, cylindrical, spherical, and irregular polyhedral enclosures.

13. The kit of claim 11, wherein the kit is fully integrated into a purpose-designed payload container chassis, the container being engineered to structurally complement the system and thereby maximize performance.

14. The kit of claim 11, wherein said system is configured to execute continuous settlement monitoring and correction.

15. The kit of claim 14, wherein:
said system is configured to execute robotic installation and mission-level positioning of the payload container in terrain lacking conventional preparation; and
said system is configured to execute de-installation of said payload container.

16. A system configured for autonomous, semi-autonomous, or remote-controlled deployment of a payload container, comprising:
(a) a payload container;
(b) a plurality of telescoping drilling/driving actuator assemblies;
(c) an array of orientation and environmental sensors;
(d) a control unit provided with closed-loop feedback control capability of the actuator assemblies; and
(e) a control interface and communications systems for autonomous, semi-autonomous, or remote-controlled operation, wherein said system is configured to execute robotic installation and mission-level positioning of the payload container.

17. The system of claim 16, wherein the payload container is one of: a rectilinear, a cylindrical, a spherical, or an irregular polyhedral container.

18. The system of claim 16, wherein the plurality of telescoping drilling/driving actuator assemblies; the array of orientation and environmental sensors; the control unit; and the control interface (etc. see e, f and g above) are fully integrated into a purpose-designed payload container chassis, the container chassis being engineered to structurally complement the system and thereby maximize efficiency and performance.

19. The system of claim 16, wherein said system is configured to execute continuous settlement monitoring and correction.

20. The system of claim 19, wherein:
said system is configured to execute robotic installation and mission-level positioning of the payload container in terrain lacking conventional preparation; and
said system is configured to execute de-installation of said payload container.
